(19) United States
(12) Patent Application Publication
(10) Pub. No.: US 2006/0285901 A1
(43) Pub. Date: Dec. 21, 2006

(54) IMAGE FORMING APPARATUS

(75) Inventors: Masao OOTSUKA, Osaka (JP); Noriyuki TAJIMA, Osaka (JP); Yoshitaka KITAOKA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/423,289

(22) Filed: Jun. 9, 2006

(30) Foreign Application Priority Data
Jun. 20, 2005 (JP) 2005-178784
May 1, 2006 (JP) 2006-127948

(51) Int. Cl. G03G 15/00

(52) U.S. Cl. 399/367; 399/405

(57) ABSTRACT

An image forming apparatus that enables a document ejected after image information reading is finished, and a printed sheet on which an image has been formed based on this image information, to be removed easily while the distinction between the two is clearly maintained. According to an image forming apparatus (100) of the present invention, a sheet document S whose image information has been read is ejected onto a document ejection tray (145), and a sheet Ps on which image information has been recorded is ejected onto a sheet ejection tray (151), so as to be crosswise to each other. By this means, even though sheet document S and printed sheet Ps are removed in a mutually overlapping state, sheet document S and printed sheet Ps can be distinguished from each other since their directions of ejection are crosswise to each other.

### BACKGROUND OF THE INVENTION

1. Field of the Invention

The present invention relates to an image forming apparatus such as a monochrome or color copier, printer, or facsimile that employs an image forming method such as electrophotography, electrostatic recording, ionography, or magnetic recording, and more particularly to an image forming apparatus that can eject printed paper onto the top surface of the apparatus body.

2. Description of the Related Art

Conventionally, taking user operability into consideration, in this kind of image forming apparatus a reading section comprising a flatbed scanner that reads image information of a document by means of a manual operation by the user is generally provided on the top surface of the apparatus body. Also, in this kind of image forming apparatus, an Automatic Document Feeder (ADF) that automatically feeds documents and reads image information is provided on the aforementioned reading section.

Thus, in this kind of image forming apparatus, since an automatic document feeder is provided on the uppermost part of the apparatus body, a recorded sheet on which an image has been formed in an image forming section is ejected onto a sheet ejection platform located on one side of the apparatus body. As the sheet ejection platform projects from the side of the apparatus body, this image forming apparatus requires a larger installation area than appears to be necessary.

Thus, in recent years, image forming apparatuses have been proposed with a configuration in which a space is formed in the waist section of the apparatus body between the reading section and image forming section, and a printed sheet ejection section is formed in this space (see, for example, Unexamined Japanese Patent Publication No. 2003-307996). This image forming apparatus requires a smaller installation area since, except for a manual tray that is opened and used in special cases, there is no member projecting from the side of the apparatus body.

However, since this image forming apparatus has a configuration whereby the paper ejection section formed in the waist section of the apparatus body is concealed behind the operation panel at the front of the apparatus body, the aforementioned reading section, or the like, there are problems in terms of the visibility and ease of removal of a printed sheet ejected into the ejection section. There are further problems in that, since a space is formed in the waist section of the apparatus body, the height of the apparatus body is increased, construction of the housing and configuration of the exterior are complicated, and additional costs are required for reinforcement of the apparatus body and so forth.

Thus, prior to the present application, the present applicants proposed an image forming apparatus configured so as to enable a printed sheet to be ejected onto the uppermost part of the automatic document feeder (see, for example, Unexamined Japanese Patent Publication No. HEI 8-286450).

FIG. 1 is a schematic cross-sectional drawing of this image forming apparatus.

In image forming apparatus 10 shown in FIG. 1, an image reading apparatus (flatbed scanner 20) and automatic document feeder (ADF 30) are provided on the top of the apparatus body, and these apparatuses 20 and 30 are formed as clamshell-shaped mechanisms that are hinged so as to be able to open and close with respect to image forming apparatus 10. By this means, image forming apparatus 10 can eject a printed sheet onto the uppermost part of the apparatus body, enabling an ejected printed sheet to be checked and removed easily. Furthermore, as there is no member projecting from the side of this image forming apparatus 10, the installation area of the apparatus body can be made smaller.

In recent years, image forming apparatuses have become able to copy a document so faithfully that a copy is indistinguishable from the original document at first glance. Consequently, with an image forming apparatus capable of performing such high-quality image forming, if original documents and printed sheets are inadvertently stacked together, it may not be possible to distinguish between the two. Therefore, it is desirable for an image forming apparatus of this kind to be configured so that it is possible to distinguish clearly between an original document and a printed sheet when they are removed from the apparatus.

However, in the image forming apparatus in FIG. 1, the direction of transportation of a document fed and ejected by the automatic document feeder is the same as the direction of transportation of a printed sheet ejected onto the sheet ejection platform, and therefore the orientation of documents stacked on the original document ejection platform and the orientation of printed sheets stacked on the sheet ejection platform are the same. Consequently, if ejected original documents and printed sheets become interleaved when removed, ejected original documents and printed sheets may become mixed up and indistinguishable from each other.

### SUMMARY OF THE INVENTION

It is an object of the present invention to provide a highly convenient image forming apparatus that enables a document ejected after its image information has been read, and a printed sheet on which an image has been formed based on this image information, to be removed easily while remaining differentiated.

According to an aspect of the invention, an image forming apparatus is provided with an image forming section that forms an image, a sheet ejection platform that holds printed paper on which an image has been formed by the image forming section and that is ejected toward a top surface of an apparatus body, a document reading section that reads a document, a document feed platform that holds a document that is automatically fed to the document reading section, and a document ejection platform that holds a document fed from the document feed platform and ejected, wherein a direction of ejection of printed paper placed on the sheet ejection platform intersects a direction of ejection of a document placed on the document ejection platform.

### BRIEF DESCRIPTION OF THE DRAWINGS

The above and other objects and features of the invention will appear more fully hereinafter from a consideration of the following description taken in conjunction with the accompanying drawing wherein one example is illustrated by way of example, in which:

FIG. 1 is a schematic cross-sectional drawing showing an example of a conventional image forming apparatus;

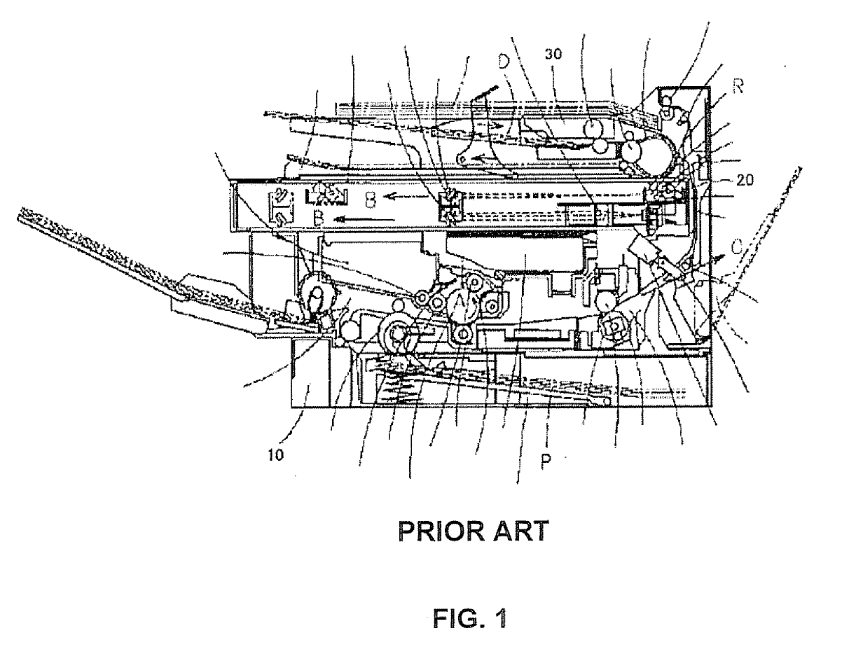

FIG. 2 is a schematic oblique drawing showing the external appearance of an image forming apparatus according to Embodiment 1 of the present invention;

FIG. 3 is a schematic partial cross-sectional drawing showing the configuration of an image forming apparatus according to Embodiment 1 of the present invention viewed from one side;

FIG. 4 is a schematic cross-sectional drawing showing the configuration of a document reading section and automatic document feeder when an image forming apparatus according to Embodiment 1 of the present invention is viewed from the front;

FIG. 5 is a schematic cross-sectional drawing showing the configuration of a document reading section and automatic document feeder after image reading when an image forming apparatus according to Embodiment 1 of the present invention is viewed from the front;

FIG. 6 is a schematic oblique drawing showing the external appearance of a variant of the image forming apparatus in FIG. 1 that has a single ejection tray;

FIG. 7 is a flowchart for explaining an example of a printing operation when ejection of sheet documents S and ejection of printed sheets Ps are performed one sheet at a time;

FIG. 8 is a drawing showing an example of the state of sheet documents S and printed sheets Ps ejected by means of the operations in FIG. 7;

FIG. 9 is a flowchart for explaining an example of a printing operation when ejection of sheet documents S and ejection of printed sheets Ps are each performed in batch mode;

FIG. 10 is a drawing showing an example of the state of sheet documents S and printed sheets Ps ejected by means of the operations in FIG. 9;

FIG. 11 is a drawing showing another example of the state of sheet documents S and printed sheets Ps ejected by means of the operations in FIG. 9;

FIG. 12 is a schematic oblique drawing showing an overview of an image forming apparatus according to Embodiment 2 of the present invention;

FIG. 13 is a schematic cross-sectional drawing showing the configuration of an image forming apparatus according to Embodiment 2 of the present invention viewed from the front;

FIG. 14 is a schematic oblique drawing showing the external appearance of an image forming apparatus according to Embodiment 3 of the present invention;

FIG. 15 is a schematic partial cross-sectional drawing showing an image forming apparatus according to Embodiment 3 of the present invention viewed from one side;

FIG. 16 is a schematic cross-sectional drawing showing the configuration of a document reading section and automatic document feeder when an image forming apparatus according to Embodiment 3 of the present invention is viewed from the front;

FIG. 17 is a schematic cross-sectional drawing showing the configuration of a document reading section and automatic document feeder after image reading when an image forming apparatus according to Embodiment 3 of the present invention is viewed from the front;

FIG. 18 is a schematic oblique drawing showing the external appearance of an image forming apparatus according to Embodiment 4 of the present invention;

FIG. 19 is a schematic cross-sectional drawing showing the configuration of a document reading section and automatic document feeder when an image forming apparatus according to Embodiment 4 of the present invention is viewed from the front;

FIG. 20 is a schematic oblique drawing showing the external appearance of an image forming apparatus according to Embodiment 5 of the present invention;

FIG. 21 is a schematic partial cross-sectional drawing showing an image forming apparatus according to Embodiment 5 of the present invention viewed from one side;

FIG. 22 is a schematic oblique drawing showing the external appearance of an image forming apparatus according to Embodiment 6 of the present invention;

FIG. 23 is a first top view of an image forming apparatus according to Embodiment 6 of the present invention;

FIG. 24 is a second top view of an image forming apparatus according to Embodiment 6 of the present invention;

FIG. 25 is a schematic oblique drawing showing the external appearance of an image forming apparatus according to Embodiment 7 of the present invention;

FIG. 26 is a first top view of an image forming apparatus according to Embodiment 7 of the present invention;

FIG. 27 is a second top view of an image forming apparatus according to Embodiment 7 of the present invention; and

FIG. 28 is a third top view of an image forming apparatus according to Embodiment 7 of the present invention.

### DESCRIPTION OF THE PREFERRED EMBODIMENTS

With reference now to the accompanying drawings, embodiments of the present invention will be explained in detail below. Configuration elements and equivalent parts in the drawings having the same configuration or function are assigned the same codes, and descriptions thereof are not repeated.

### Embodiment 1

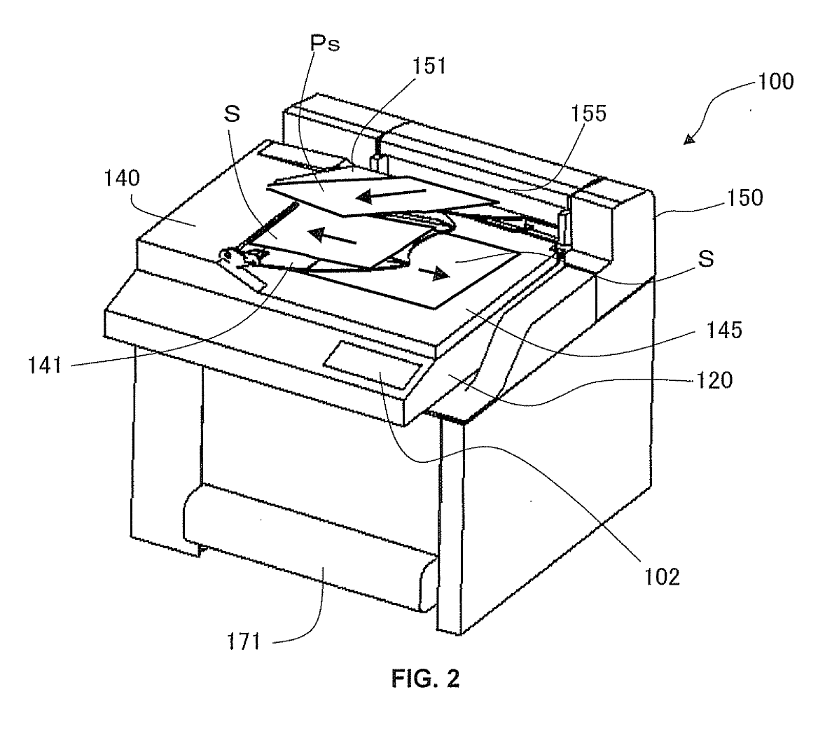

First, an image forming apparatus according to Embodiment 1 of the present invention will be described using FIG. 2 through FIG. 5. An image forming apparatus according to this embodiment has a configuration as a multifunctional composite device having a copy function that copies a paper document, book, or the like, a print function that prints out electronic data and so forth transmitted from a PC or the like, and a facsimile function that transmits to and receives from a fax machine or the like. It goes without saying that the present invention is also applicable to an image forming apparatus provided with only a single function.

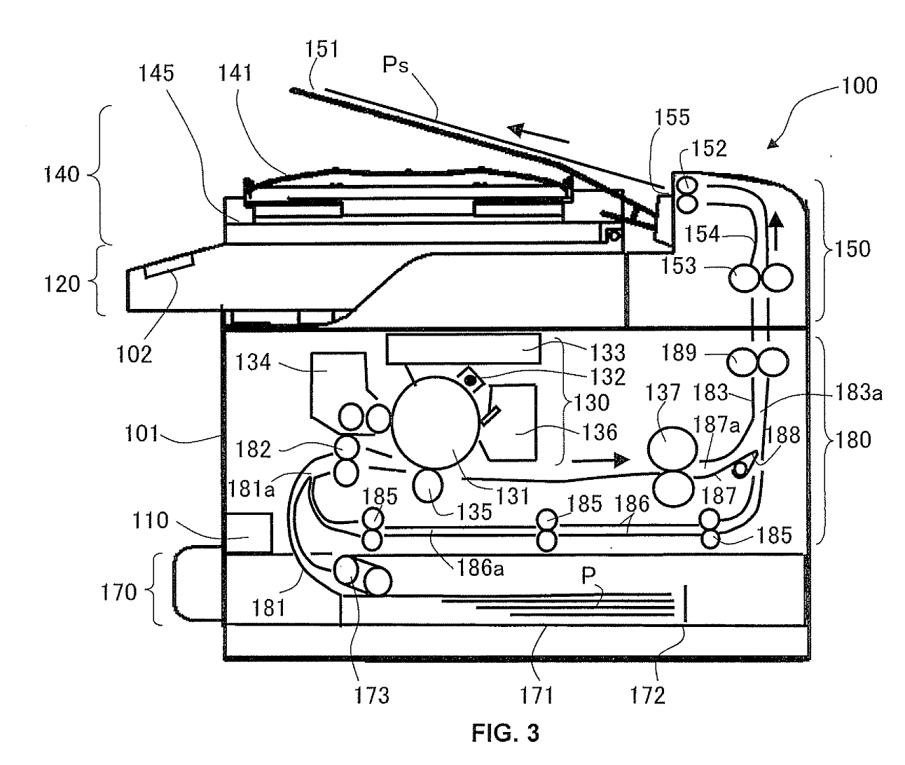

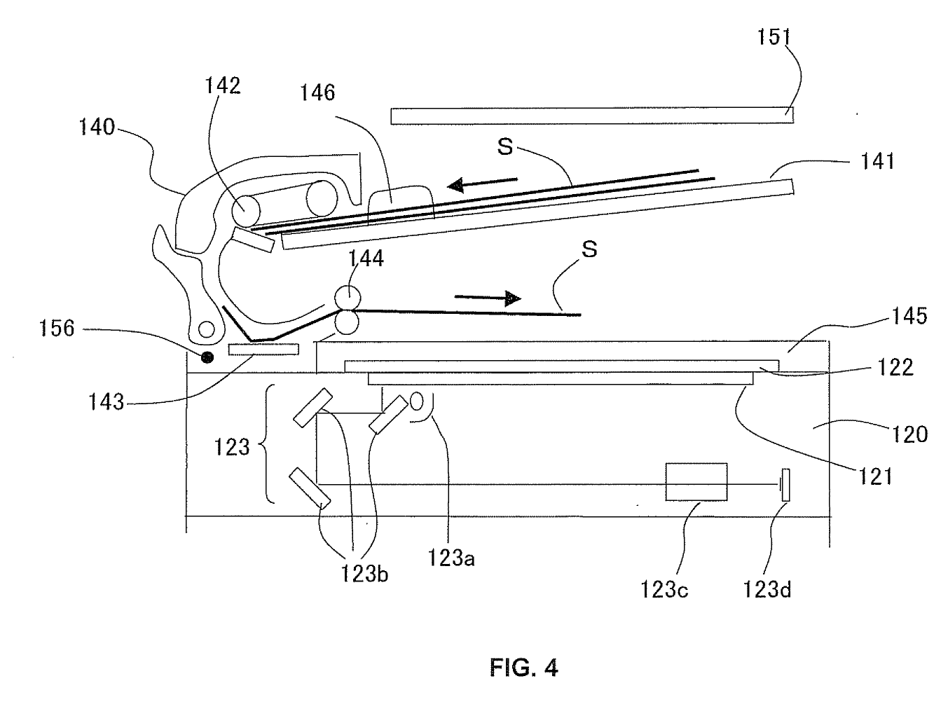

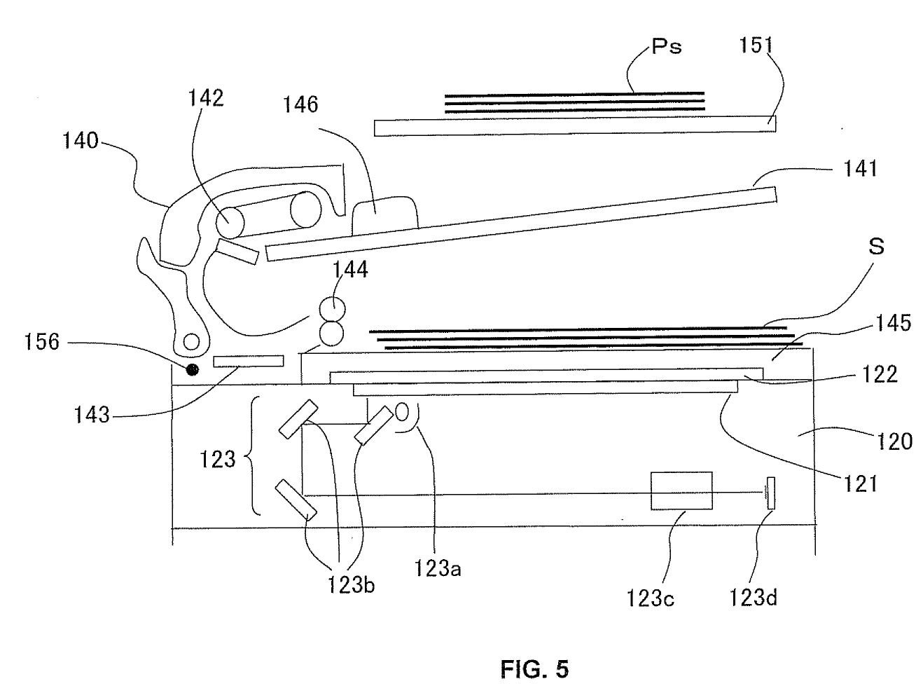

FIG. 2 is a schematic oblique drawing showing the external appearance of an image forming apparatus according to Embodiment 1 of the present invention, FIG. 3 is a schematic partial cross-sectional drawing showing the configuration of an image forming apparatus according to Embodiment 1 of the present invention viewed from one side, FIG. 4 is a schematic cross-sectional drawing showing the configuration of a document reading section and automatic document feeder when an image forming apparatus according to Embodiment 1 of the present invention is viewed from the front, and FIG. 5 is a schematic cross-sectional drawing showing the configuration of a document reading section and automatic document feeder after image reading when an image forming apparatus according to Embodiment 1 of the present invention is viewed from the front.

Broadly speaking, image forming apparatus 100 is equipped with a receiving section 110 that receives information of an image to be formed on a recording medium (for example, a sheet of copy paper, an OHP sheet, or the like: hereinafter referred to as “recording paper” or simply “paper”), a reading section 120 that reads an image of a document that is to be copied, an image forming section 130 that holds and forms an unfixed image on recording paper, an automatic document feeder 140 that automatically and continuously feeds a plurality of documents to reading section 120, a sheet ejection section 150 that ejects and stacks recording paper on which an image has been formed, a paper feed section 170 that holds a plurality of sheets of recording paper, and a transportation system 180 that transports recording paper held in paper feed section 170 to image forming section 130.

Image forming apparatus 100 is also provided with a LAN port to which a LAN (Local Area Network) is connected, a modular jack to which a public circuit is connected, a card slot in which a memory card is inserted, and so forth (none of which is shown).

Receiving section 110 receives image information input from an external device such as a PC (Personal Computer), fax machine, storage medium (for example, a memory card), or the like, via a LAN (including a wireless LAN) or public circuit.

As shown in FIG. 3, reading section 120 is located in the upper part of apparatus body 101 of image forming apparatus 100. Reading section 120 is composed of a document placement platform (contact glass) 121, on which a sheet document S, book document B, or the like is placed manually by the user, a document cover 122 that covers sheet document S (or book document B) placed on document placement platform 121, a scanning optical system 123 that reads image information by scanning an image of sheet document S (or book document B), and so forth.

Scanning optical system 123 is composed of, for example, a light source 123a, mirrors 123b, a lens 123c, an imaging device (CCD: Charge-Coupled Device) 123d, and so forth. Document cover 122 is configured so as to have a dual function as a document ejection tray 145 serving as the document ejection platform of automatic document feeder 140.

Image forming section 130 is located approximately in the center part of apparatus body 101 of image forming apparatus 100. Image forming section 130 is composed of a photo sensitive body 131, an electrifier 132, an exposure apparatus 133, a developing apparatus 134, a transfer roller 135, a cleaning apparatus 136, a fixing apparatus 137, and so forth.

Automatic document feeder 140 is located on the upper part of reading section 120. As shown in FIG. 4, automatic document feeder 140 includes a document feed tray 141 serving as a document feed platform that holds automatically fed sheet documents S, document feed rollers 142 serving as a document feeding section, a scanner 143 serving as a document reading section, document ejection rollers 144 serving as a document ejection section, document ejection tray 145 serving as a document ejection platform, and so forth.

A freely displaceable document position regulating plate 146 that determines the side position of placed sheet documents S is attached to document feed tray 141. Document feed tray 141 is also provided with a document sensor (not shown) serving as a document detecting section that detects the presence of sheet documents S to be fed by automatic document feeder 140. When this document sensor detects that sheet documents S have been placed on document feed tray 141, automatic document feeder 140 shifts to a state in which these sheet documents S can be fed.

Document feed rollers 142 separate sheet documents S placed (set) on document feed tray 141 and feed them toward scanner 143 one sheet at a time. Scanner 143 reads image information of sheet documents S separated and fed by document feed rollers 142. Document ejection rollers 144 eject a sheet document S for which image reading by scanner 143 is finished onto document ejection tray 145. Document feed rollers 142 and document ejection rollers 144 are positioned so that their axes are orthogonal to the direction of ejection of sheet documents S.

That is to say, as shown in FIG. 4, automatic document feeder 140 is configured so that sheet documents S placed (set) on document feed tray 141 are separated and fed by document feed rollers 142 one sheet at a time, and a sheet documents S whose image information has been read is ejected by document ejection rollers 144 onto document ejection tray 145 located below document feed tray 141. Also, automatic document feeder 140 is configured so as to be able to open and close with respect to apparatus body 101 about a spindle 156 together with document ejection tray 145.

Sheet ejection section 150 includes a sheet ejection tray 151 serving as a sheet ejection platform, and sheet ejection rollers 152, sheet transportation rollers 153, sheet ejection guide plates 154, and a sheet ejection aperture 155, serving as a sheet ejection section. This sheet ejection section 150 is configured so that a printed sheet Ps on which an image has been formed by image forming section 130 is ejected onto the uppermost part of apparatus body 101. That is to say, sheet ejection tray 151 of sheet ejection section 150 is positioned higher than apparatus body 101 and automatic document feeder 140 located on the upper part of the apparatus body.

In FIG. 2 and FIG. 3, sheet ejection tray 151 is located on top of document feed tray 141, and holds printed sheets Ps ejected from the apparatus. Sheet ejection rollers 152 eject printed sheets Ps onto sheet ejection tray 151. Sheet transportation rollers 153 transport printed sheets Ps toward sheet ejection rollers 152. Sheet ejection guide plates 154 guide printed sheets Ps transported toward sheet ejection rollers 152 by sheet transportation rollers 153. Sheet ejection aperture 155 ejects printed sheets Ps. Sheet ejection rollers 152 and sheet transportation rollers 153 are positioned so that their axes are orthogonal to the direction of ejection of printed sheets Ps.

Here, the axes of sheet ejection rollers 152 of sheet ejection section 150 are positioned so as to intersect the axes of document ejection rollers 144 of automatic document feeder 140 (see FIG. 3 and FIG. 4). Therefore, a printed sheet Ps ejected from sheet ejection rollers 152 and a sheet document S ejected from document ejection rollers 144 are ejected crosswise to each other.

Spindle 156 is a rotating spindle for opening and closing document cover 122 that is brought close to reading section 120 with respect to apparatus body 101 together with automatic document feeder 140 (see FIG. 4). Spindle 156 is positioned so that its axis lies in approximately the same direction as the axes of document ejection rollers 144. Therefore, the opening and closing direction of document cover 122 is the same as the direction of ejection of sheet documents S, and intersects the direction of ejection of printed sheets Ps. Here, “opening and closing direction” means the direction orthogonal to the axial direction of spindle 156.

As shown in FIG. 3, paper feed section 170 is composed of a paper feed cassette 171 that holds sheets P as a recording medium such as copy paper, OHP sheets, or the like, a cassette housing section 172 that holds this paper feed cassette 171, a separating and feeding section 173 that separates and feeds sheets P held in paper feed cassette 171 one sheet at a time, and so forth. A plurality of paper feed cassettes 171 can be housed in cassette housing section 172. This makes it possible to simultaneously accommodate different kinds of sheets P differentiated by sheet material or size.

As shown in FIG. 3, transportation system 180 includes paper feed guide plates 181 that guide sheets P held in paper feed section 170 toward image forming section 130. A paper feed path 181a is formed by these paper feed guide plates 181. At the exit of paper feed path 181a are located registration rollers 182 that send sheets P to image forming section 130 at predetermined timing.

Transportation system 180 is also provided with sheet ejection guide plates 183 that guide a sheet P on which an unfixed image has been fixed by fixing apparatus 137 of image forming section 130 toward sheet ejection section 150 at the top of apparatus body 101. A sheet ejection path 183a is formed by these sheet ejection guide plates 183.

Transportation system 180 also includes reverse transportation rollers 185 and reverse transportation guide plates 186 that send a printed sheet Ps into paper feed path 181a with its image formation side reversed. A reverse transportation path 186a is formed by reverse transportation rollers 185 and reverse transportation guide plates 186.

At the confluence of this reverse transportation path 186a and an ejection transportation path 187a of sheets P ejected from fixing apparatus 137 of image forming section 130, a reverse switchover lug 188 is provided that switches the transportation path of a sheet P exiting ejection transportation path 187a to the reverse transportation path 186a side. Also, downstream of reverse switchover lug 188 in the ejection direction, there are located forward/reverse rotation rollers 189 that transport sheets P in a topside ejection direction and reverse transportation direction. By this means, a sheet P with an image formed on one side by image forming section 130 can be sent to image forming section 130 again, and an image can also be formed on the other side of sheet P (duplex printing).

Next, the operation of image forming apparatus 100 configured as described above will be explained.

This image forming apparatus 100 has three modes: manual copy mode, external input print mode, and automatic copy mode. The operation of image forming apparatus 100 in each of these print modes will be described below.

(Manual Copy Mode)

In manual copy mode, image information obtained by CCD 123d of reading section 120 reading a sheet document S or book document B placed on document placement platform 121 manually is copied to recording paper.

In manual copy mode, referring to FIG. 4, document cover 122 of reading section 120 is opened together with automatic document feeder 140, pivoting about spindle 156, exposing document placement platform 121. Then a sheet document S or book document B to be copied is manually placed on this exposed document placement platform 121 by the user.

Reading section 120 is provided with a document size sensor (not shown) as a manual document detecting section that detects the presence of sheet document S or book document B placed on document placement platform 121.

Referring to FIG. 4, when the user presses the Copy button on operation panel 102 of the apparatus body (see FIG. 2) when it has been detected by the aforementioned document size sensor that sheet document S or book document B has been placed on document placement platform 121, scanning optical system 123 operates and CCD 123d reads image data of sheet document S or book document B. This image data read by CCD 123d is converted to print data by an image processing apparatus (not shown), and is then input to exposure apparatus 133 of image forming section 130 at predetermined timing.

When the aforementioned Copy button is pressed, photosensitive body 131 rotates in a predetermined direction, and the surface of photosensitive body 131 is uniformly charged by electrifier 132. Exposure apparatus 133 irradiates the surface of this uniformly charged photo sensitive body 131 with print data converted by the aforementioned image processing apparatus as a laser beam. As a result of this laser beam irradiation, an electrostatic latent image of the read document is formed on the surface of photosensitive body 131.

This electrostatic latent image is made visible (made into a toner image) by means of toner supplied from developing apparatus 134. This toner image is transferred by transfer roller 135 to sheet P fed by registration rollers 182 at predetermined timing, and is then fixed by fixing apparatus 137.

Printed sheet Ps on which an image of sheet document S or book document B has been formed in this way passes along sheet ejection path 183a, and is ejected and placed onto sheet ejection tray 151 of sheet ejection section 150.

(External Input Print Mode)

In external input print mode image information from a PC, fax machiner memory card, or suchlike external device input to receiving section 110 is printed out onto recording paper.

In external input print mode, image information (image data) input to receiving section 110 from a PC, fax machine, memory card, or suchlike external device is stored (accumulated) in memory (not shown) serving as a storage section provided in apparatus body 101. Image data stored in this memory is converted to print data by an image processing apparatus (not shown), and input to exposure apparatus 133 at predetermined timing.

Then, as in manual copy mode described above, this print data is printed out onto sheet P by image forming section 130.

Thus, in external input print mode, printed sheet Ps on which an image has been fixed by fixing apparatus 137 is transported toward sheet ejection section 150 via sheet ejection path 183a, and is ejected and placed onto sheet ejection tray 151 by sheet ejection rollers 152.

(Automatic Copy Mode)

In automatic copy mode, image information of sheet documents S set on document feed tray 141 read by scanner 143 of automatic document feeder 140 is copied onto recording paper.

In automatic copy mode, sheet documents S to be fed automatically are set on document feed tray 141 of automatic document feeder 140, as shown in FIG. 4. When this is done, a document sensor (not shown) serving as a document detecting section that detects the presence of sheet documents S to be fed by automatic document feeder 140 is turned on. When this document sensor is turned on, preparations for light emission by the lamp of scanner 143 that reads image information of sheet document S and so forth are performed.

When the user presses the Copy button on operation panel 102 of apparatus body 101 while the document sensor is on, a sheet document S on document feed tray 141 is fed by document feed rollers 142 (see FIG. 4). By this means, sheet document S is transported while being held in close contact with the document reading glass of scanner 143, and image information of sheet document S is read. When image information of sheet document S has been read, sheet document S is ejected onto document ejection tray 145 of automatic document feeder 140 by document ejection rollers 144 (see FIG. 5).

Image information (image data) of sheet document S read by scanner 143 of automatic document feeder 140 in this way is stored in the aforementioned memory, as in the case of external input print mode described above. Image data stored in this memory is converted to print data by the aforementioned image processing apparatus, and input to exposure apparatus 133 at predetermined timing.

As in the case of manual copy mode described above, this print data input to exposure apparatus 133 is radiated onto the surface of uniformly charged photosensitive body 131 as a laser beam at predetermined timing, and is fixed onto sheet P as a toner image by fixing apparatus 137.

Printed sheet Ps on which an image has been formed in this automatic copy mode is transported toward sheet ejection section 150 via sheet ejection path 183a, as in the case of external input print mode described above. Furthermore, this printed sheet Ps is transported along sheet ejection guide plates 154 by sheet transportation rollers 153, and is ejected and placed onto sheet ejection tray 151 located above the top surface of document feed tray 141 by sheet ejection rollers 152 (see FIG. 3).

In this way, image forming processing is performed by image forming apparatus 100. In this image forming apparatus 100, printed sheets Ps and sheet documents S are placed in the upper part of apparatus body 101, enabling printed sheets Ps and sheet documents S to be removed easily.

As described above, in image forming apparatus 100 of this embodiment, document ejection rollers 144 that eject a sheet document S for which image information reading is finished, and sheet ejection rollers 152 that eject a printed sheet Ps afterimage forming, are installed in a mutually crosswise fashion (see FIG. 2). Therefore, the ejection direction of a sheet document S for which image information reading is finished, and the ejection direction of a printed sheet Ps after image forming, also have a mutually crosswise orientation.

That is to say, in this image forming apparatus 100, when image forming is performed using automatic document feeder 140 (as in automatic copy mode, for example), a sheet document S whose image information has been read, and a sheet Ps on which image information has been recorded, are ejected in a mutually crosswise fashion. By this means, sheet documents S on document ejection tray 145 and printed sheets Ps on sheet ejection tray 151 are placed in a mutually crosswise fashion.

Consequently, in this image forming apparatus 100, when a sheet document S whose image information has been read and a sheet Ps on which image information has been recorded are removed, even if the two are removed directly in an overlapping state, since their directions of ejection are mutually crosswise, sheet document S and printed sheet Ps can easily be distinguished from each other.

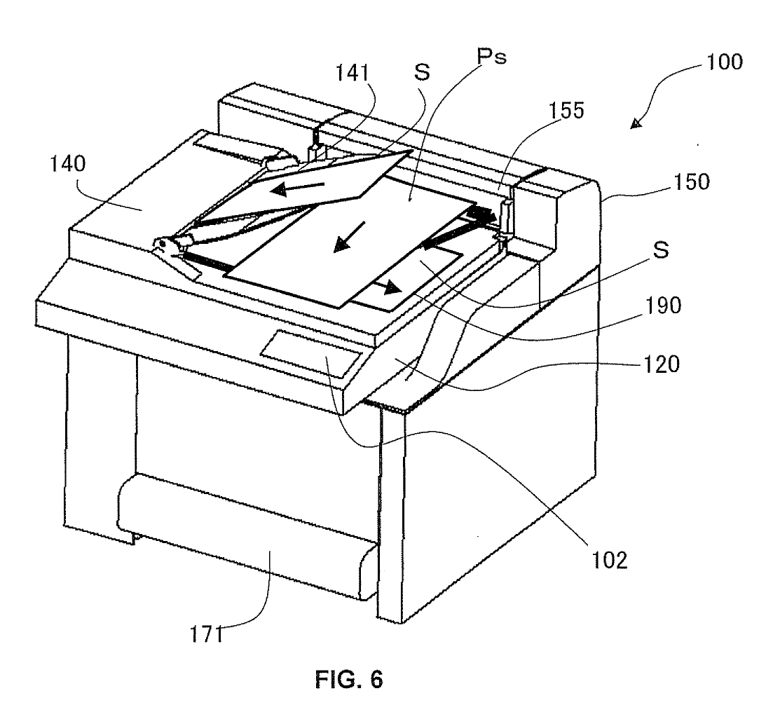

In the image forming apparatus in FIG. 2 through FIG. 5 described above, a sheet document S and a printed sheet Ps are ejected separately, with sheet document S being ejected onto document ejection tray 145 and printed sheet Ps being ejected onto sheet ejection tray 151, but the configuration of an image forming apparatus of the present invention is not limited to this. For example, as shown in FIG. 6, document ejection tray 145 and sheet ejection tray 151 may be made a single ejection tray 190, with sheet documents S and printed sheets Ps being ejected onto this ejection tray 190. With this configuration, also, sheet documents S and printed sheets Ps are ejected and placed crossing each other in different directions, enabling sheet documents S and printed sheets Ps to be easily distinguished from each other.

Cases can also be considered in which, in an image forming apparatus having a single ejection tray 190 as shown in FIG. 6, feeding and reading of sheet documents S and ejection of printed sheets Ps are performed one sheet at a time, or feeding and reading of sheet documents S are performed in batch mode and image information (image data) is stored in memory, after which printing to sheets P is performed in batch mode, and printed sheets Ps are ejected. Printing operations for these cases will be described below.

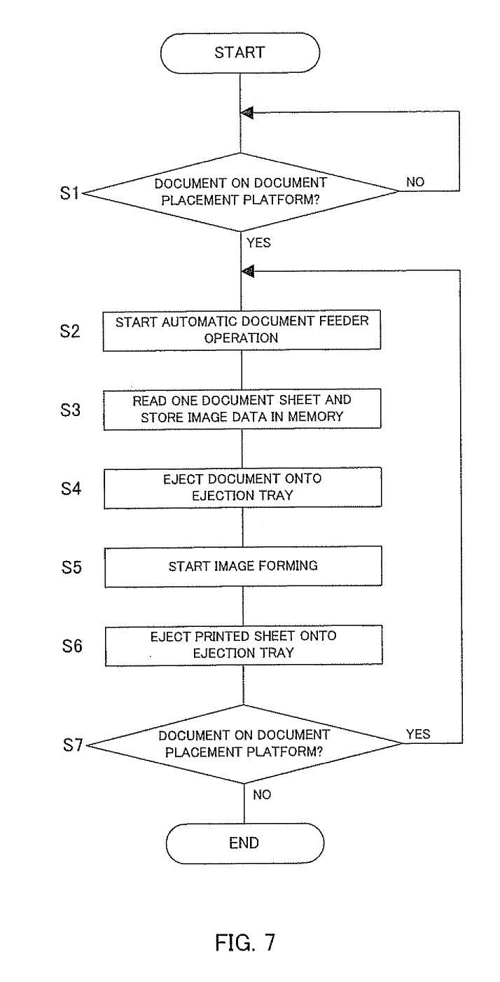

First, a printing operation in the case in which feeding and reading of sheet documents S and ejection of printed sheets Ps are performed one sheet at a time will be described using the flowchart in FIG. 7. FIG. 7 is a flowchart for explaining an example of a printing operation when ejection of sheet documents S and ejection of printed sheets Ps are performed one sheet at a time.

On detecting that sheet documents S have been placed on document feed tray 141 (S1), automatic document feeder 140 starts feeding of one sheet (for example, topmost sheet document S) from among sheet documents S placed on document feed tray 141 (S2). Next, reading section 120 reads image information of fed sheet document S and stores this image information in memory (S3), and sheet document S whose image information has been read is ejected onto single ejection tray 190 (S4). When image information is recorded in memory, image forming section 130 starts image forming of image information recorded in memory for sheets P held in paper feed section 170 (S5), and a printed sheet Ps on which an image has been formed is ejected on top of sheet document S on single ejection tray 190, in a different direction from sheet document S (S6).

The processing flow then proceeds to a copying operation for the next sheet document S on document feed tray 141 (S7: YES), and the processing in step S1 through step SG is repeated until copying of all the sheet documents on document feed tray 141 ends (S7: NO).

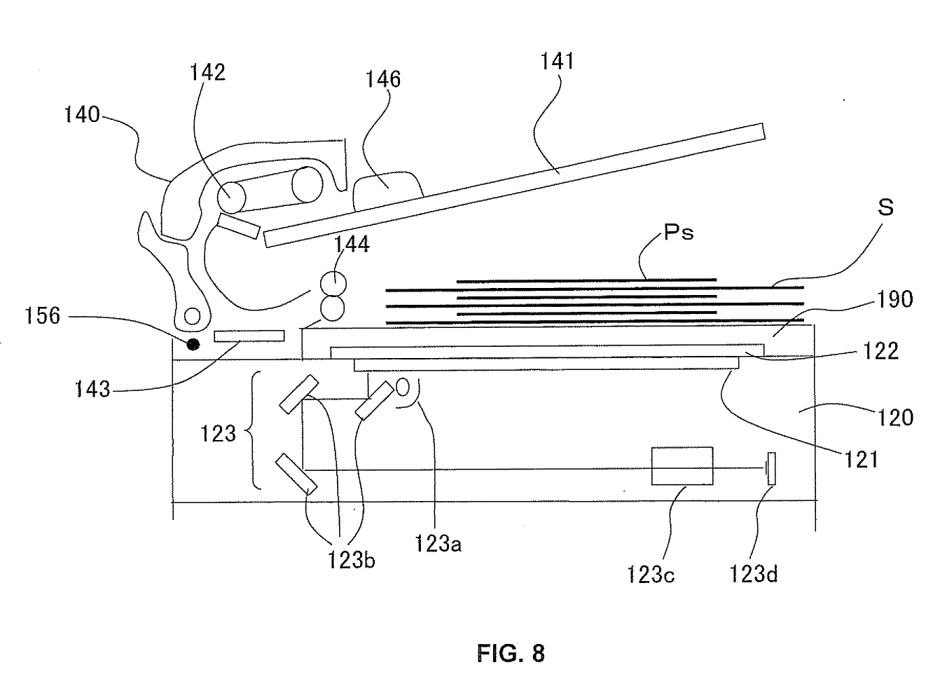

In this case, sheet documents S after document reading and printed sheets Ps are alternately placed on single ejection tray 190 one sheet at a time in different directions (see FIG. 8). By this means, it is easy to check that the same image information is printed on a printed sheet Ps as on a sheet document S, one sheet at a time, with sheet documents S and printed sheets Ps distinguished from each other.

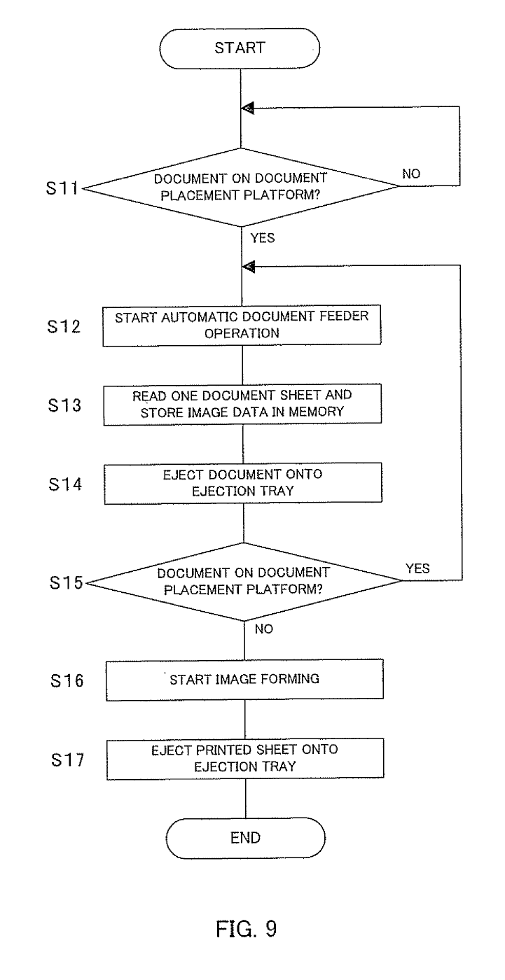

Next, using the flowchart in FIG. 9, a printing operation will be described for the case in which feeding and reading of sheet documents S are performed in batch mode and image information (image data) is stored in memory, after which printing to sheets P is performed in batch mode, and printed sheets Ps are ejected. FIG. 9 is a flowchart for explaining an example of a printing operation when ejection of sheet documents S and ejection of printed sheets Ps are each performed in batch mode.

On detecting that sheet documents S have been placed on document feed tray 141 (S11), automatic document feeder 140 starts feeding of one sheet (for example, topmost sheet document S) from among sheet documents S placed on document feed tray 141 (S12). Next, reading section 120 reads image information of fed sheet document S and stores this image information in memory (S13), and sheet document S whose image information has been read is ejected onto single ejection tray 190 (S14). The processing flow then proceeds to image information read processing for the next sheet document S on document feed tray 141 (S15: YES), and the processing in step S11 through step S14 is repeated until image information reading ends for all the sheet documents on document feed tray 141 (S15: NO).

When image information of all the sheet documents on document feed tray 141 has been read and stored in memory, and the sheet documents have been ejected onto single ejection tray 190, image forming section 130 starts image forming of all the image information recorded in memory for sheets P held in paper feed section 170 (S16), and printed sheets Ps on which an image has been formed are ejected successively on top of sheet documents S on single ejection tray 190 (S17).

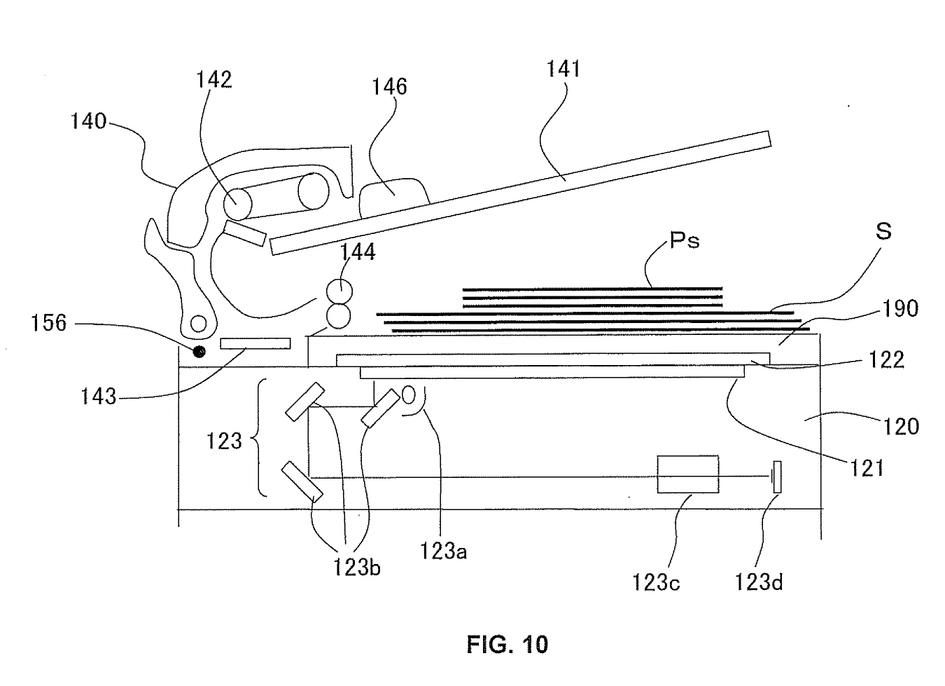

In this case, sheet documents S after document reading are placed on single ejection tray 190, and printed sheets Ps are placed on top of sheet documents S in a different direction from sheet documents S (see FIG. 10). By this means, sheet documents S and printed sheets Ps can easily be distinguished from each other.

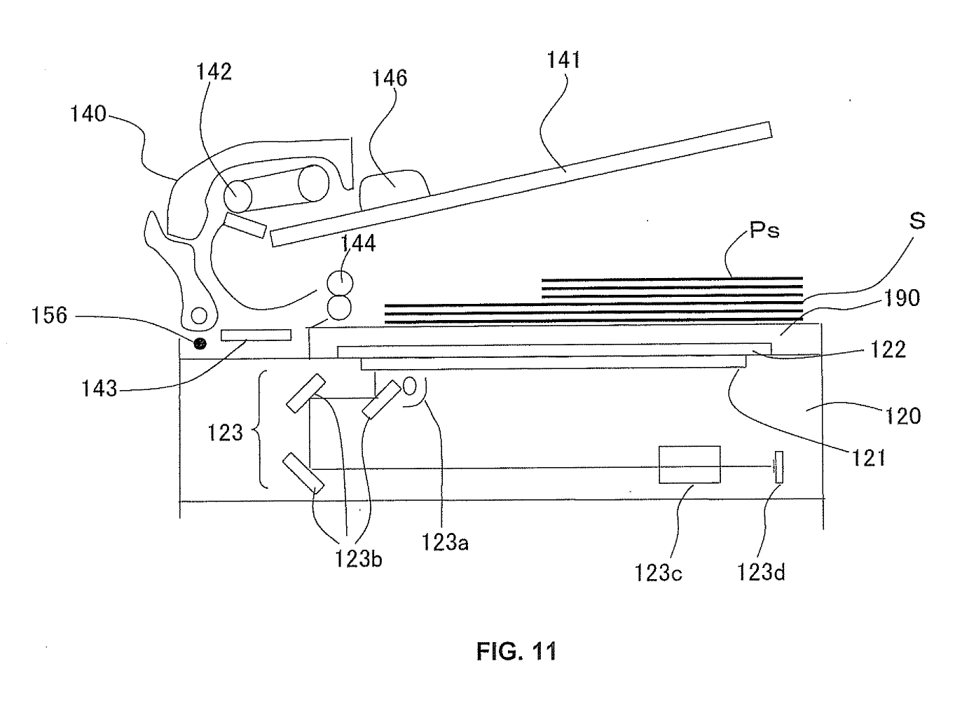

Automatic document feeder 140 and sheet ejection section 150 may also be configured so that at least parts of edges of ejected sheet documents S and printed sheet Ps are aligned vertically (see FIG. 11).

Thus, according to this embodiment, an ejected document S whose image information has been read, and a printed sheet Ps on which an image has been formed based on this image information, are ejected onto respective ejection platforms so as to be in mutually crosswise directions, enabling document S and printed sheet Ps to be easily removed in a state in which the distinction between them is clear.

### Embodiment 2

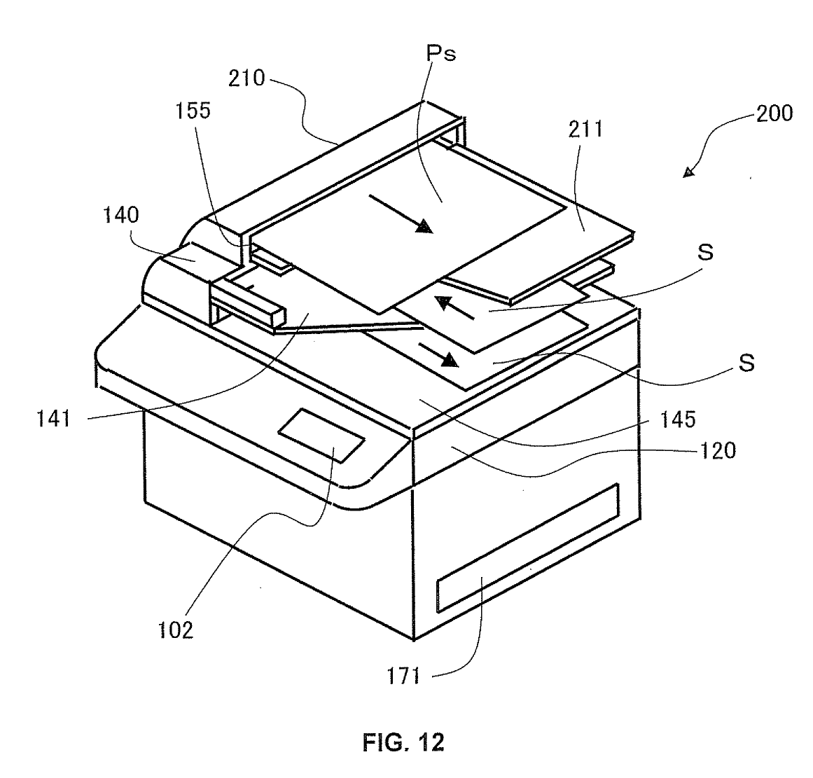

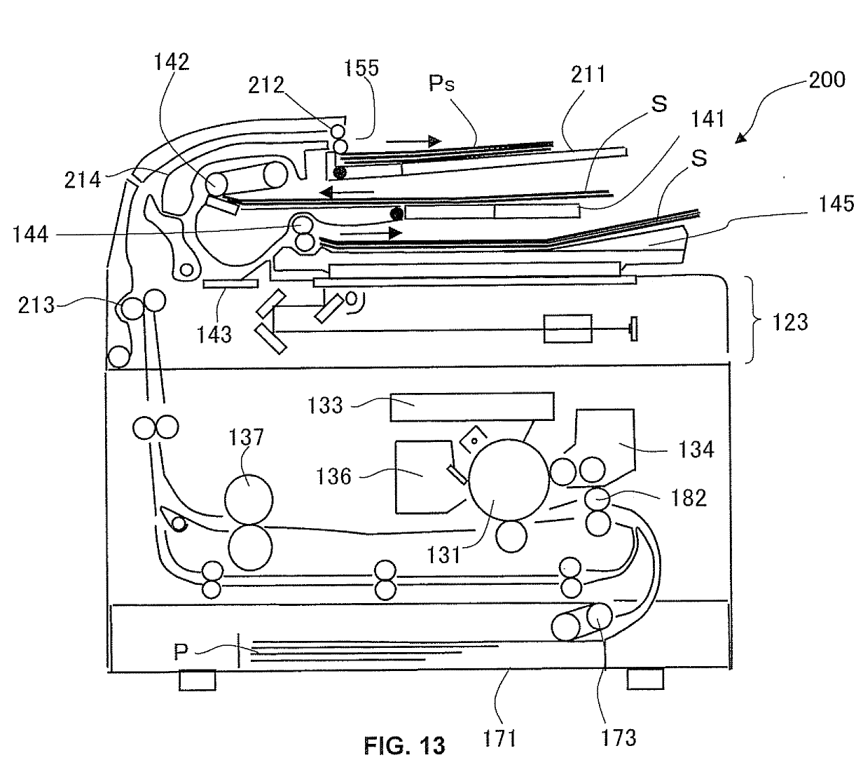

Next, an image forming apparatus according to Embodiment 2 of the present invention will be described using FIG. 12 and FIG. 13.

FIG. 12 is a schematic oblique drawing showing an overview of an image forming apparatus according to Embodiment 2 of the present invention, and FIG. 13 is a schematic cross-sectional drawing showing the configuration of an image forming apparatus according to Embodiment 2 of the present invention viewed from the front. In the following description, descriptions of parts having the same configuration and performing the same operation as in Embodiment 1 are omitted, and elements having the same function are assigned the same reference numbers.

In an image forming apparatus 200 of this embodiment, the configuration and operation of sheet ejection section 210 differ from those of sheet ejection section 150 in Embodiment 1. Therefore, for this embodiment, the configuration and operation of sheet ejection section 210 will be described.

Sheet ejection section 210 ejects and holds recording paper on which an image has been formed. Specifically, sheet ejection section 210 ejects printed sheet Ps so that the lengthwise direction of printed sheet Ps and the lengthwise direction of sheet documents S intersect. That is to say, sheet documents S whose image information has been read and printed sheets Ps on which image information has been recorded are ejected in a mutually crosswise fashion.

Sheet ejection section 210 includes a sheet ejection tray 211 serving as a sheet ejection platform, and sheet ejection rollers 212, sheet transportation rollers 213, and sheet ejection guide plates 214, serving as a sheet ejection mechanism. This sheet ejection section 210 is configured so that a printed sheet Ps on which an image has been formed by image forming section 130 is ejected onto the uppermost part of apparatus body 101. That is to say, sheet ejection tray 211 of sheet ejection section 210 is positioned higher than automatic document feeder 140.

Sheet ejection tray 211 is located on top of document feed tray 141, and holds printed sheets Ps ejected from the apparatus. Sheet ejection rollers 212 eject printed sheets Ps onto sheet ejection tray 211. Sheet transportation rollers 213 transport printed sheets Ps toward sheet ejection rollers 212. Sheet ejection guide plates 214 guide printed sheets Ps transported toward sheet ejection rollers 212 by sheet transportation rollers 213.

Sheet ejection rollers 212 eject printed sheets Ps so that the lengthwise direction of printed sheets Ps and the direction of transportation of printed sheets Ps are approximately perpendicular. Therefore, printed sheets Ps ejected from sheet ejection rollers 212 and sheet documents S ejected from document ejection rollers 144 are ejected crosswise to each other.

Next, the operation of image forming apparatus 200 configured as described above will be explained.

Of the above-mentioned three modes (manual copy mode, external input print mode, and automatic copy mode), automatic copy mode will be described here.

First, sheet documents S to be fed automatically are set on document feed tray 141 so that the lengthwise direction of sheet documents S and the direction of transportation of sheet documents S are approximately parallel. When this is done, a document sensor (not shown) serving as a document detecting section that detects the presence of sheet documents S to be fed by automatic document feeder 140 is turned on. When this document sensor is turned on, preparations for light emission by the lamp of scanner 143 that reads image information of sheet document S and so forth are performed.

When the user presses the Copy button on operation panel 102 while the document sensor is on, a sheet document S on document feed tray 141 is fed by document feed rollers 142. By this means, sheet document S is transported while being held in close contact with the document reading glass of scanner 143, and image information of sheet document S is read. When image information of sheet document S has been read, sheet document S is ejected onto document ejection tray 145 of automatic document feeder 140 by document ejection rollers 144. As in a paper feed operation, the lengthwise direction of ejected sheet document S is approximately parallel to the sheet document transportation direction.

Image information (image data) of sheet document S read by scanner 143 of automatic document feeder 140 in this way is stored in memory (not shown). Image data stored in this memory is converted to print data by an image processing apparatus (not shown), and input to exposure apparatus 133 at predetermined timing.

Here, image data stored in the aforementioned memory is accessed and converted to print data in a different order from that in which it was read. First, sheet document S is transported so that the lengthwise direction of sheet document S and transportation direction of sheet document S are approximately parallel, and image data reading is performed sequentially from a short side of sheet document S. Then image data for one sheet document S is stored in the aforementioned memory, and image data is extracted and converted to print data sequentially from a long side of the document.

In this way, print data for performing printing from a long side is generated using image data read from a short side. That is to say, image forming apparatus 200 can be configured so that the image data direction of sheet document S and the direction of print data recorded on sheet P intersect.

Print data input to exposure apparatus 133 is radiated onto the surface of uniformly charged photosensitive body 131 as a laser beam at predetermined timing, and is fixed onto sheet P as a toner image by fixing apparatus 137.

Printed sheet Ps on which an image has been formed in this automatic copy mode is ejected onto sheet ejection tray 211 by means of sheet ejection rollers 212, sheet transportation rollers 213, sheet ejection guide plates 214, and so forth. The lengthwise direction of ejected printed sheet Ps is approximately perpendicular to the direction of transportation of printed sheet Ps. That is to say, an ejected document S whose image information has been read, and a printed sheet Ps on which an image has been formed based on this image information, are ejected onto respective ejection platforms so that their lengthwise directions intersect.

In FIG. 12 and FIG. 13, sheet documents S and printed sheets Ps are ejected onto different trays, but the same kind of effect can also be obtained if sheet ejection tray 211 and document ejection tray 145 are made a single ejection tray.

Also, feeding and reading of sheet document S, and ejection of printed sheet Ps, can each be performed in batch mode. In this case, automatic document feeder 140 and sheet ejection section 210 may be configured so that at least parts of edges of ejected sheet documents S and printed sheet Ps are aligned vertically. According to this configuration, sheet documents S and printed sheets Ps stacked on the ejection tray can be removed more easily.

Thus, according to this embodiment, a sheet document S and printed sheet Ps are ejected onto respective ejection platforms so that their lengthwise directions intersect, enabling document S and printed sheet Ps to be easily removed in a state in which the distinction between them is clear.

### Embodiment 3

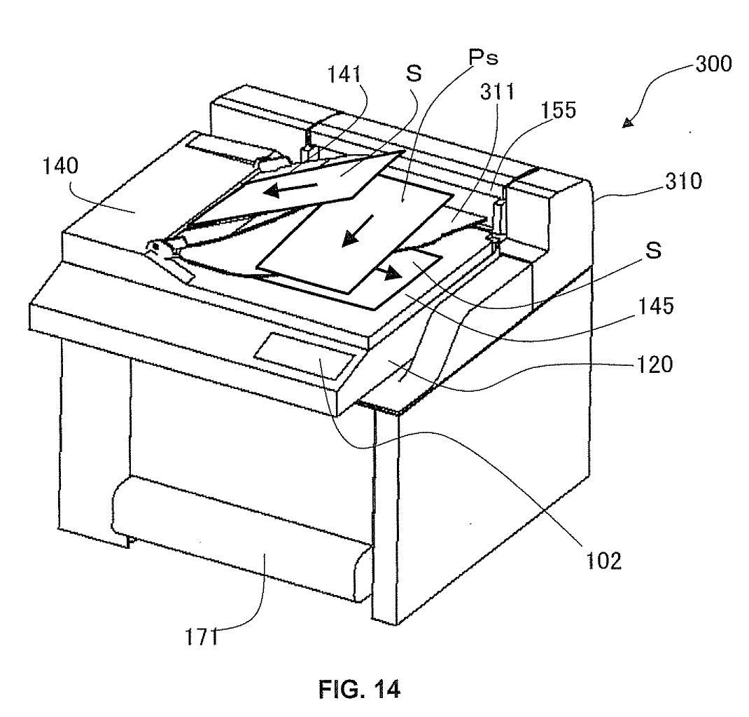

Next, an image forming apparatus according to Embodiment 3 of the present invention will be described using FIG. 14 through FIG. 17.

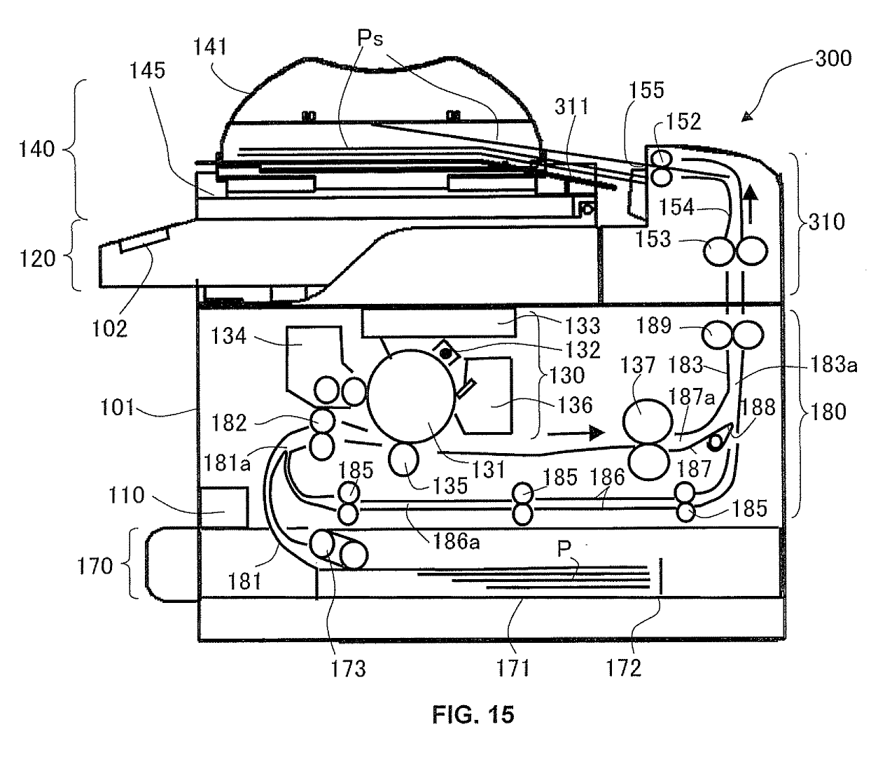

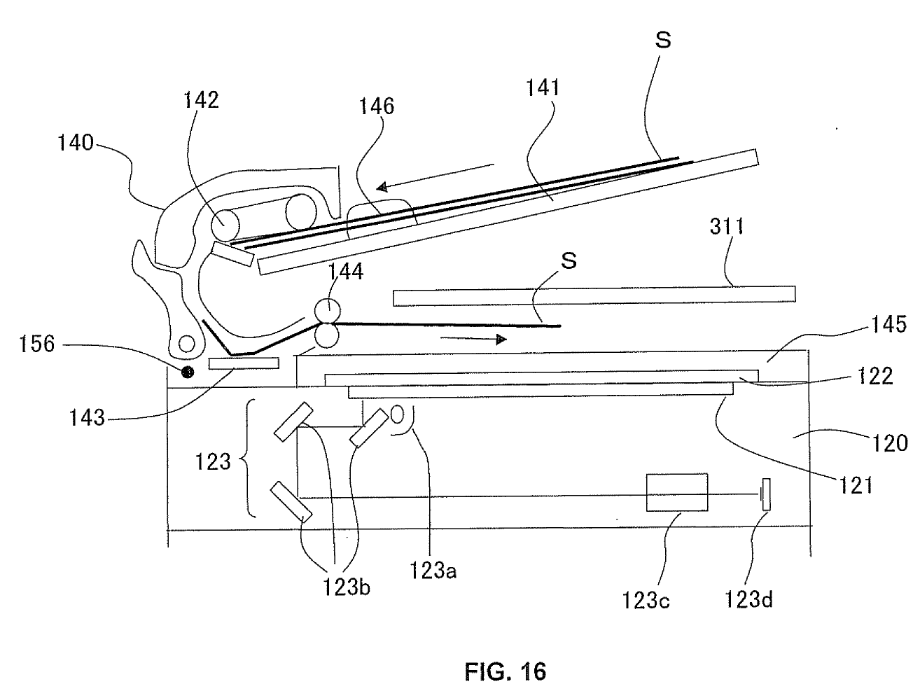

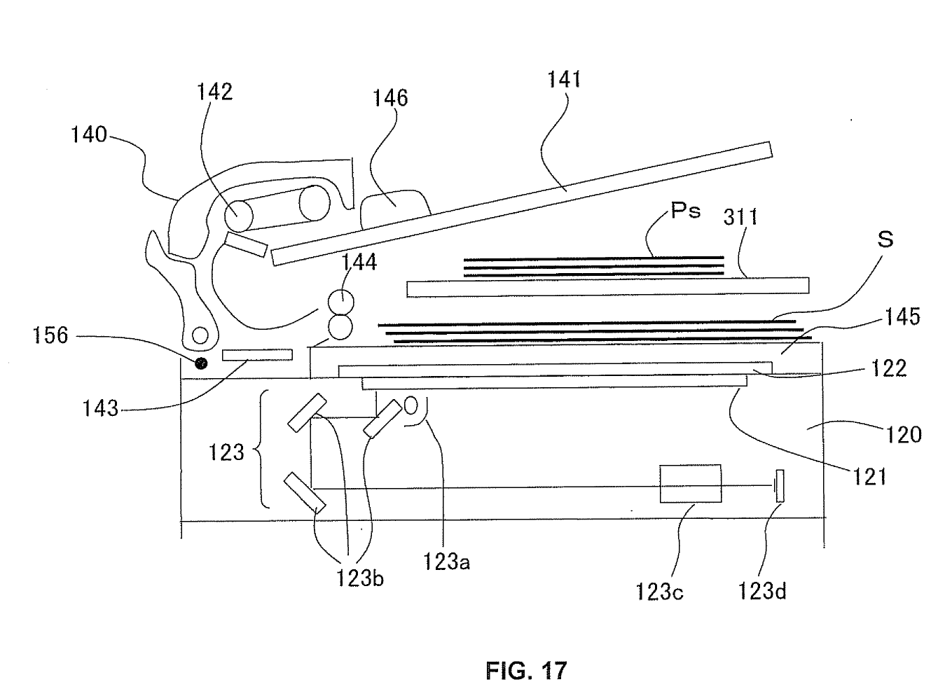

FIG. 14 is a schematic oblique drawing showing the external appearance of an image forming apparatus according to Embodiment 3 of the present invention, FIG. 15 is a schematic partial cross-sectional drawing showing an image forming apparatus according to Embodiment 3 of the present invention viewed from one side, FIG. 16 is a schematic cross-sectional drawing showing the configuration of a document reading section and automatic document feeder when an image forming apparatus according to Embodiment 3 of the present invention is viewed from the front, and FIG. 17 is a schematic cross-sectional drawing showing the configuration of a document reading section and automatic document feeder after image reading when an image forming apparatus according to Embodiment 3 of the present invention is viewed from the front. In the following description, descriptions of parts having the same configuration and performing the same operation as in Embodiment 1 are omitted, and elements having the same function are assigned the same reference numbers.

In an image forming apparatus 300 of this embodiment, the installation location of sheet ejection tray 311 of sheet ejection section 310 differs from that of sheet ejection tray 151 of sheet ejection section 150 in Embodiment 1.

As shown in FIG. 14 through FIG. 16, image forming apparatus 300 of this embodiment has a configuration in which sheet ejection tray 311 is positioned below document feed tray 141 and above document ejection tray 145. That is to say, sheet ejection tray 311 is installed in a position between document feed tray 141 and document ejection tray 145.

Thus, as shown in FIG. 17, printed sheets Ps stacked on sheet ejection tray 311, and sheet documents S stacked on document ejection tray 145, are in close proximity in the vertical direction, and when printed sheets Ps and sheet documents S are removed simultaneously, this can be done easily with one hand.

Also, when printed sheets Ps and sheet documents S are removed simultaneously with one hand, although printed sheets Ps and sheet documents S overlap, the difference in paper direction of ejected printed sheets Ps and sheet documents S enables them to be easily differentiated even after being overlapped.

Thus, according to this embodiment, since sheet ejection tray 311 that holds ejected printed sheets Ps, and document ejection tray 145 that holds sheet documents S, are in close proximity in the vertical direction, when printed sheets Ps and sheet documents S are removed simultaneously, this can be done easily with one hand.

In this embodiment, document feed tray 141 is installed above document ejection tray 145, but when the document feed tray is installed below the document ejection tray, sheet ejection tray 311 may be installed above the document feed tray and below the document ejection tray, being positioned between the document feed tray and document ejection tray.

### Embodiment 4

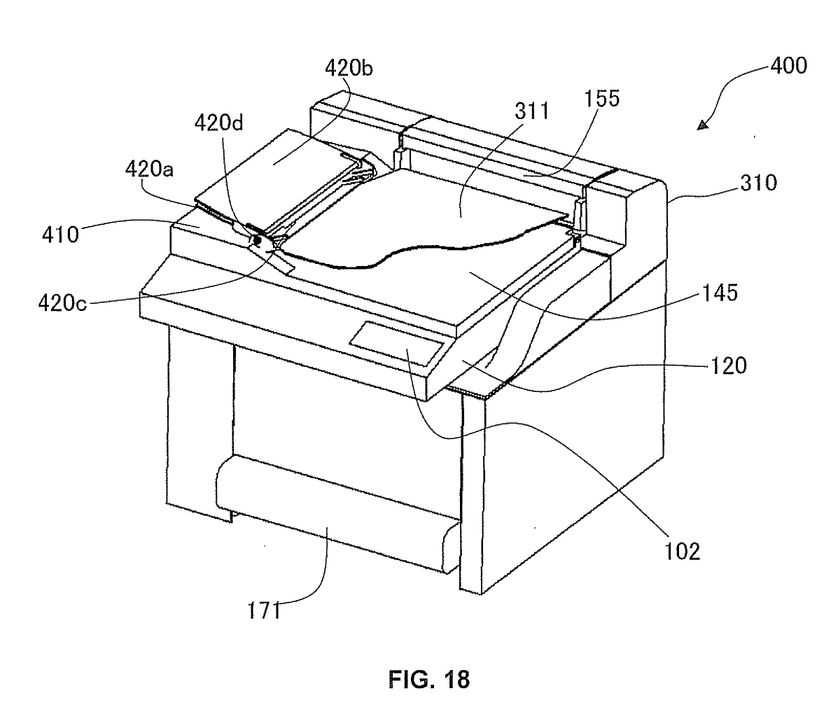

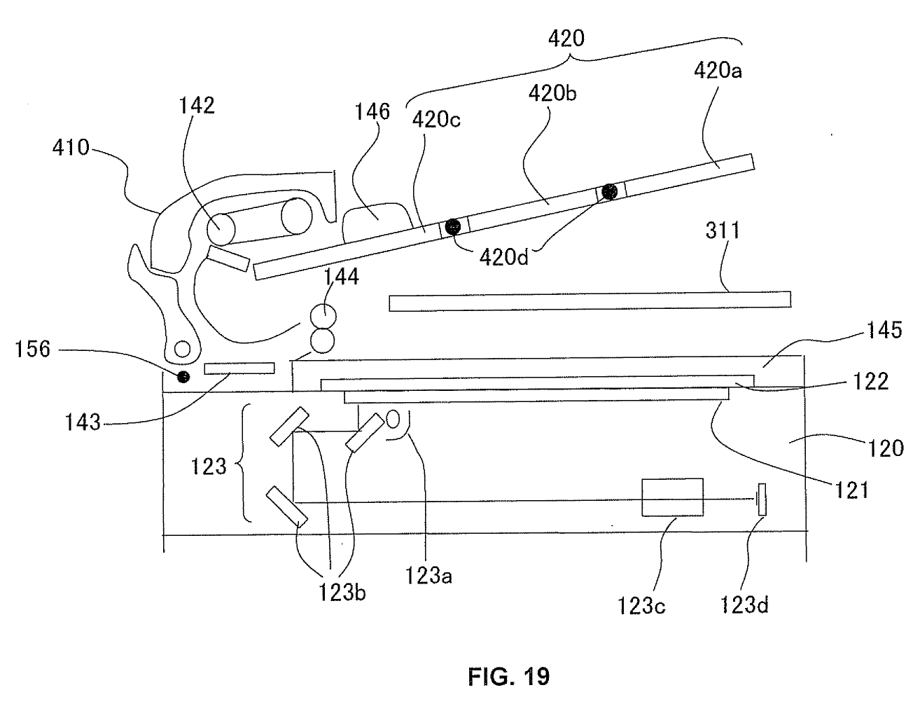

Next, an image forming apparatus according to Embodiment 4 of the present invention will be described using FIG. 18 and FIG. 19.

FIG. 18 is a schematic oblique drawing showing the external appearance of an image forming apparatus according to Embodiment 4 of the present invention, and FIG. 19 is a schematic cross-sectional drawing showing the configuration of a document reading section and automatic document feeder when an image forming apparatus according to Embodiment 4 of the present invention is viewed from the front. In the following description, descriptions of parts having the same configuration and performing the same operation as in Embodiment 3 are omitted, and elements having the same function are assigned the same reference numbers.

In an image forming apparatus 400 of this embodiment, the configuration and operation of document feed tray 420 of automatic document feeder 410 differ from those of document feed tray 141 of automatic document feeder 140 in Embodiment 3. Therefore, for this embodiment, the configuration and operation of document feed tray 420 of automatic document feeder 410 will be described.

As shown in FIG. 18 and FIG. 19, document feed tray 420 is divided into auxiliary document feed trays 420a, 420b, and 420c, and is configured so that the respective auxiliary document feed trays are linked by means of feed tray spindles 420d. Auxiliary document feed tray 420c is located in automatic document feeder 410. Auxiliary document feed tray 420b is pivoted in a freely rocking fashion on a feed tray spindle 420d fitted in auxiliary document feed tray 420c. Similarly, auxiliary document feed tray 420a is pivoted in a freely rocking fashion on a feed tray spindle 420d fitted in auxiliary document feed tray 420b.

With this automatic document feeder 410, since document feed tray 420 is divided, the document feed tray can be folded up, and the shape of the document feed tray can be changed according to the operating environment of image forming apparatus 400. For example, in cases other than when sheet documents S are set on document feed tray 420 in automatic copy mode (for example, in manual copy mode or external input print mode), document feed tray 420 can be folded up, further exposing sheet ejection tray 311.

Thus, in frequently used external input print mode, folding up document feed tray 420 enables the visibility of printed sheets Ps ejected onto sheet ejection tray 311 to be improved, and printed sheets Ps to be removed easily.

Also, by dividing document feed tray 420 into a plurality of trays, document feed tray 420 can be accommodated within the installation area of image forming apparatus 400 when folded up, and does not project from the body of the apparatus, making a large installation area unnecessary.

Furthermore, a suitable shape of document feed tray 420 for the operating environment (such as the size of sheet document S) can be implemented. For example, when a maximum-size sheet document S is ejected, all the auxiliary document feed trays are deployed, and when a minimum-size sheet document S is ejected, only auxiliary document feed tray 420c is deployed.

As well as being performed manually by the user, unfolding and folding of the auxiliary document feed trays can be performed automatically by providing a sensor (not shown) that detects the recording paper size and print mode, and performing unfolding or folding operations in accordance with the sensing results.

Thus, according to this embodiment, document feed tray 420 of automatic document feeder 410 is divided and made foldable, and the shape of document feed tray 420 is made variable, enabling image forming processing to be performed flexibly in accordance with the recording paper size and/or print mode.

In this embodiment, document feed tray 420 has been described as being composed of three auxiliary document feed trays, but the configuration of document feed tray 420 is not limited to this. For example, document feed tray 420 may be composed of two auxiliary document feed trays, or of four or more auxiliary document feed trays, according to recording paper sizes and print modes.

### Embodiment 5

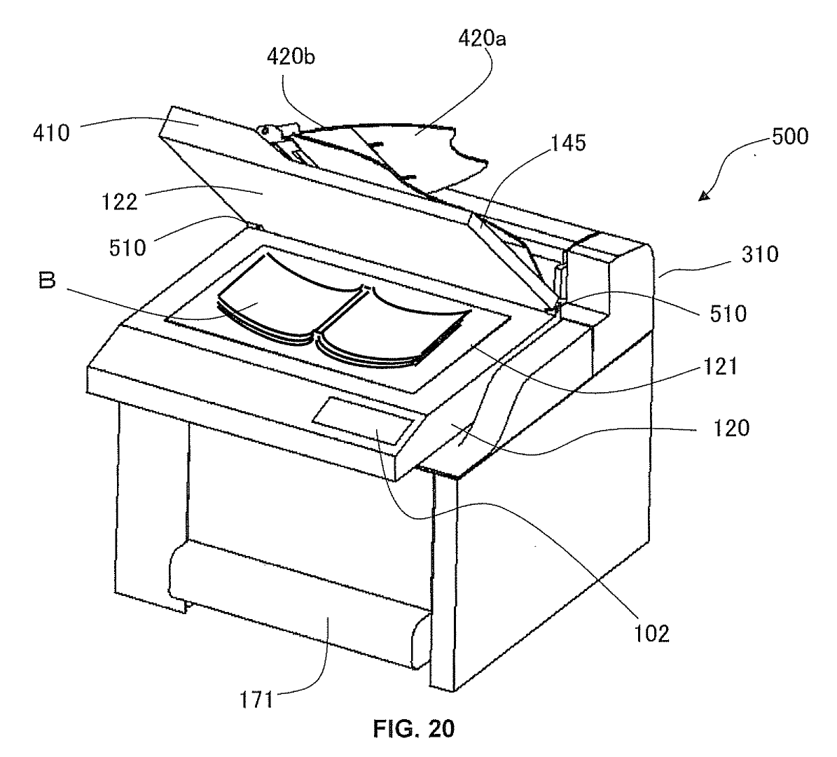

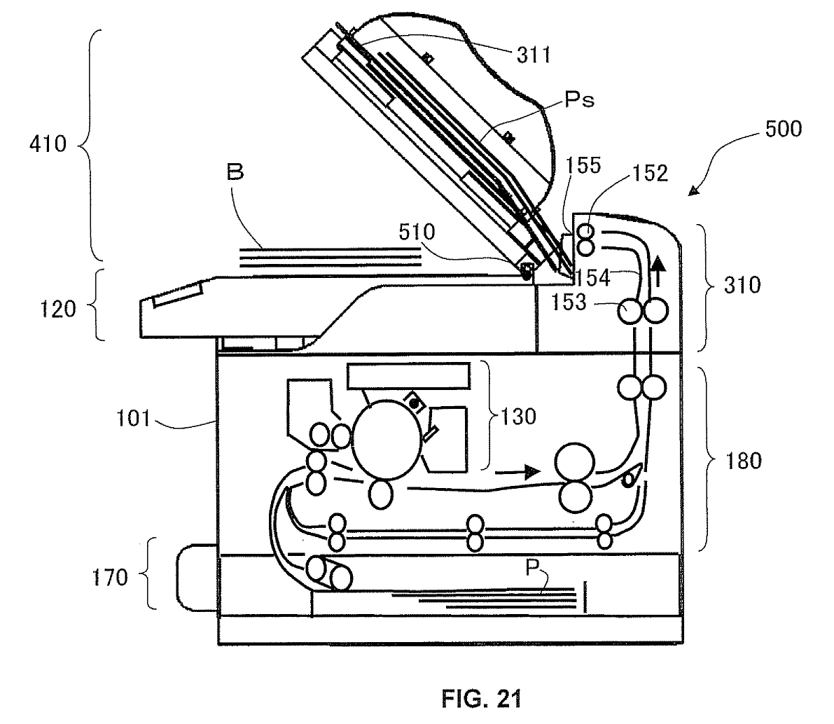

Next, an image forming apparatus according to Embodiment S of the present invention will be described using FIG. 20 and FIG. 21.

FIG. 20 is a schematic oblique drawing showing the external appearance of an image forming apparatus according to Embodiment 5 of the present invention, and FIG. 21 is a schematic partial cross-sectional drawing showing an image forming apparatus according to Embodiment 5 of the present invention viewed from one side. In the following description, descriptions of parts having the same configuration and performing the same operation as in Embodiment 4 are omitted, and elements having the same function are assigned the same reference numbers.

In an image forming apparatus 500 of this embodiment, the installation location and installation direction of cover opening/closing spindle 510 differ from those of spindle 156 in Embodiment 4. Therefore, for this embodiment, the configuration and operation of cover opening/closing spindle 510 will be described.

Cover opening/closing spindle 510 is a rotating spindle for opening and closing document cover 122 with respect to apparatus body 101 together with automatic document feeder 140. Cover opening/closing spindle 510 is positioned so that its axis lies in approximately the same direction as the axes of sheet ejection rollers 152. Therefore, the axis of cover opening/closing spindle 510 is positioned so as to intersect the direction of ejection of printed sheets Ps. Also, the opening and closing direction of document cover 122 is the same as the direction of ejection of printed sheets Ps, and intersects the direction of ejection of sheet documents S.

Cover opening/closing spindle 510 is fitted to reading section 120 in an upstream area of reading section 120 in the printed sheet Ps ejection direction. That is to say, document cover 122, document ejection tray 145, and sheet ejection tray 311 are pivoted in a freely rocking fashion on cover opening/closing spindle 510 fitted to the body of reading section 120 so as to be positioned in a plane parallel to the axial direction of sheet ejection rollers 152. By this means, document cover 122, document ejection tray 145, and sheet ejection tray 311 can be displaced upward by being opened in a plane parallel to the axial direction of cover opening/closing spindle 510 via cover opening/closing spindle 510.

Therefore, as shown in FIG. 20 and FIG. 21, with this image forming apparatus 500, even if document cover 122, document ejection tray 145, and sheet ejection tray 311 are opened in order to place a book document B on document placement platform 121 during printed sheet Ps ejection, opened document cover 122 does not obstruct sheet ejection aperture 155 of printed sheet Ps, and printed sheets Ps can be ejected onto sheet ejection tray 311.

Thus, according to this embodiment, cover opening/closing spindle 510 is fitted to reading section 120 in an upstream area of reading section 120 in the printed sheet Ps ejection direction so that its axis lies in approximately the same direction as the axes of sheet ejection rollers 152, there by enabling continuous copying operations to be carried out with the document cover open when copying a book document. That is to say, manual copying of a book document B can be carried out while ejection of printed sheets Ps is being performed in automatic copy mode, enabling user convenience to be improved.

### Embodiment 6

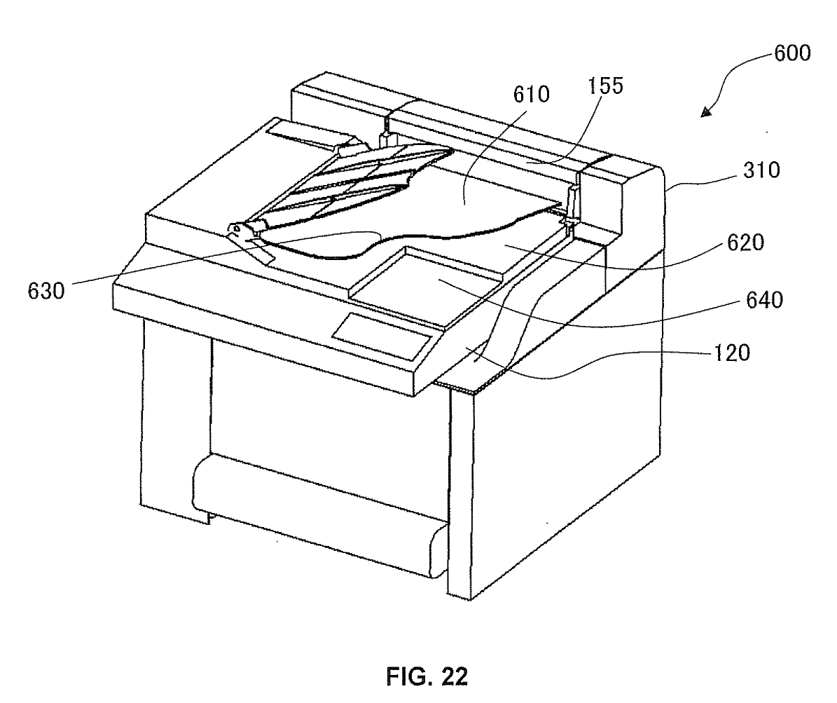

Next, an image forming apparatus according to Embodiment 6 of the present invention will be described using FIG. 22 through FIG. 24.

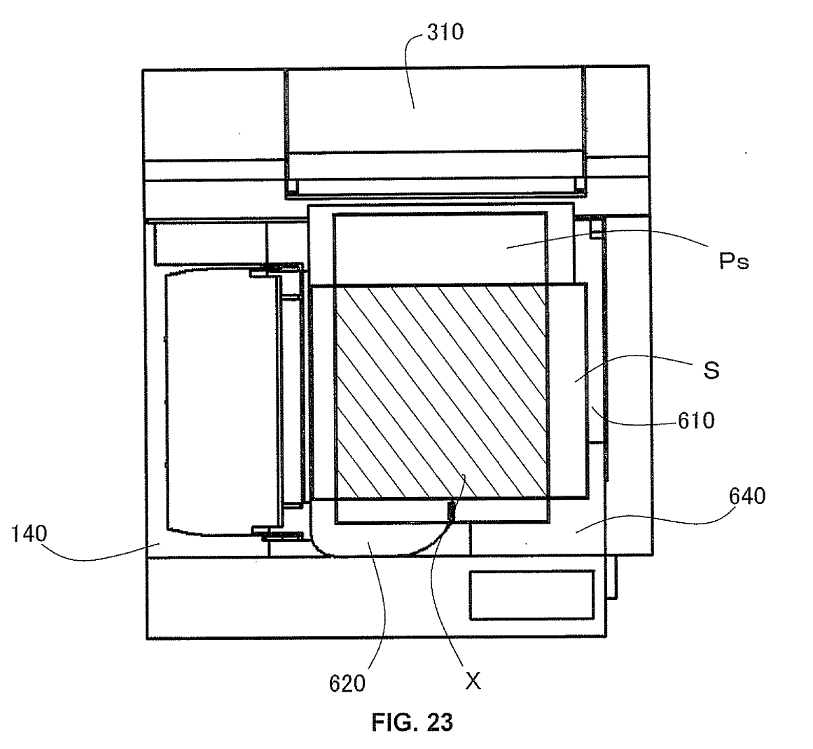

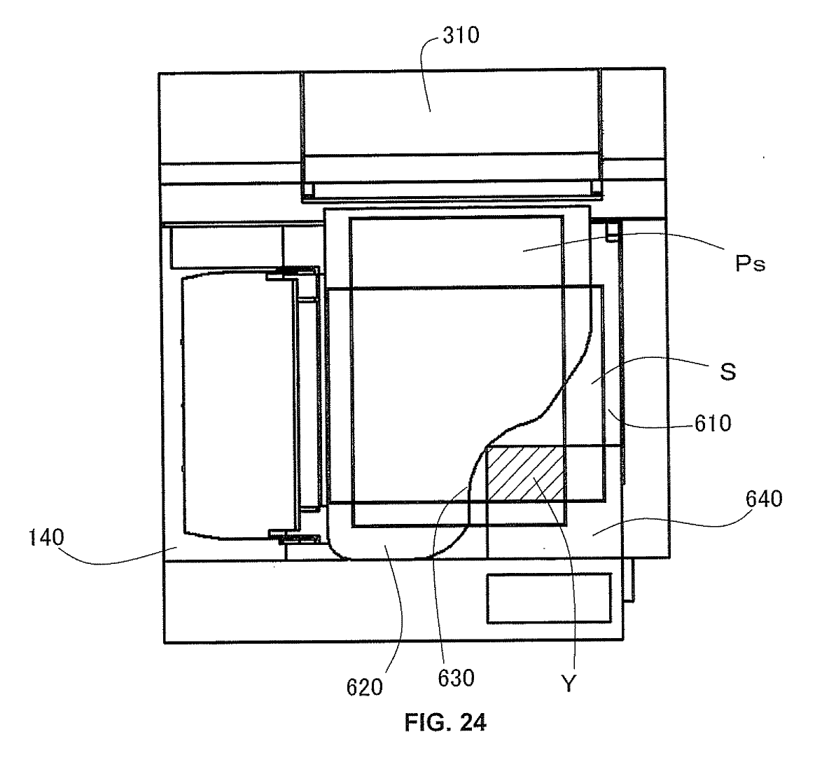

FIG. 22 is a schematic oblique drawing showing the external appearance of an image forming apparatus according to Embodiment 6 of the present invention, and FIG. 23 and FIG. 24 are top views of an image forming apparatus according to Embodiment 6 of the present invention. In the following description, descriptions of parts having the same configuration and performing the same operation as in Embodiment 3 are omitted, and elements having the same function are assigned the same reference numbers.

In an image forming apparatus 600 of this embodiment, the configuration and operation of document ejection tray 610 and sheet ejection tray 620 differ from those of document ejection tray 145 and sheet ejection tray 311 in Embodiment 3. Therefore, for this embodiment, the configuration and operation of document ejection tray 610 and sheet ejection tray 620 will be described.

Document ejection tray 610 has a cutaway section 630 in one part. The part of a sheet document S ejected onto document ejection tray 610 facing cutaway section 630 hangs in the air without touching document ejection tray 610.

Sheet ejection tray 620 has a depressed area 640 in one part. The part of a printed sheet Ps ejected onto sheet ejection tray 620 facing depressed area 640 hangs in the air without touching sheet ejection tray 620.

Cutaway section 630 of document ejection tray 610 and depressed area 640 of sheet ejection tray 620 are shaped so as to partially overlap when viewed from above. Also, document ejection tray 610 and sheet ejection tray 620 are configured so that parts of an ejected sheet document S and printed sheet Ps are ejected onto the overlapping area of cutaway section 630 and depressed area 640.

In order to grasp a printed sheet Ps and a sheet document S simultaneously with one hand, it is necessary to grasp the area where printed sheet Ps and sheet document S cross each other directly (hatched area X in FIG. 23). However, since document ejection tray 610 holding sheet documents S and sheet ejection tray 620 holding printed sheets Ps are installed separately, the major area of overlap between sheet document S and printed sheet Ps is via sheet ejection tray 620.

Looking now at the overlapping area between cutaway section 630 and depressed area 640, sheet document S and printed sheet Ps are placed in direct contact as regards this overlapping area. That is to say, by grasping the area in which cutaway section 630 and depressed area 640 overlap (hatched area Y in FIG. 24) within the area in which printed sheet Ps and sheet document S cross each other, printed sheet Ps and sheet document S can easily be removed simultaneously with one hand.

Thus, according to this embodiment, with a document ejection tray holding sheet documents S and a sheet ejection tray holding printed sheets Ps installed separately, parts of these overlap, and a space is provided in which a hand can be inserted vertically therein, enabling a sheet document S and printed sheet Ps to be removed easily with one hand.

### Embodiment 7

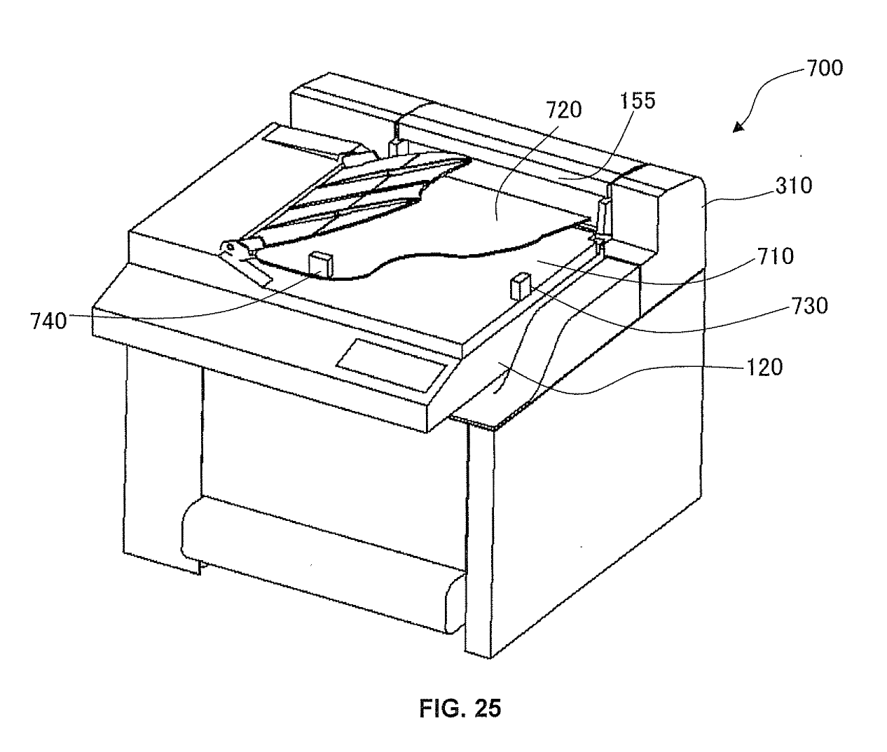

Next, an image forming apparatus according to Embodiment 7 of the present invention will be described using FIG. 25 through FIG. 28.

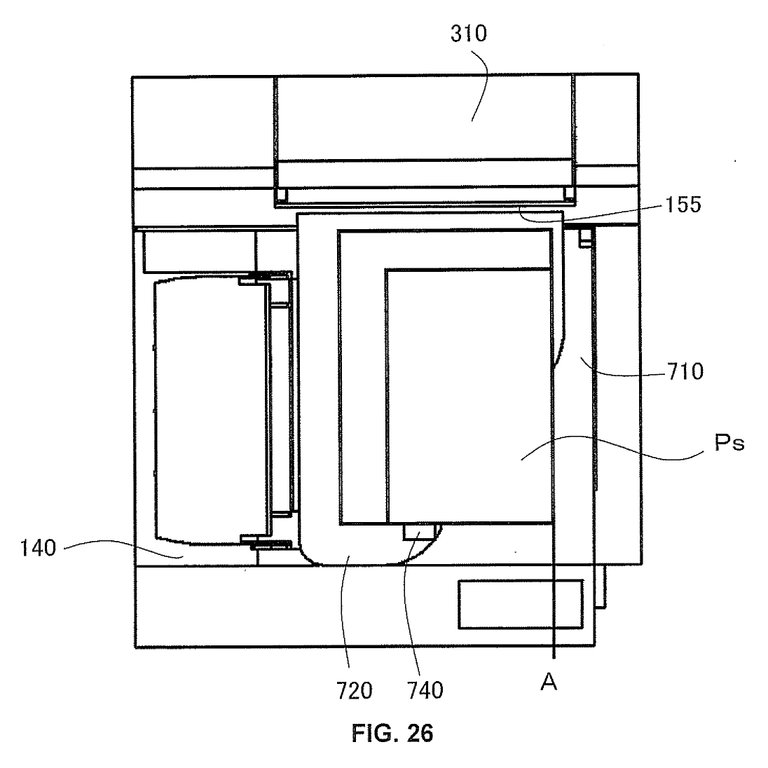

FIG. 25 is a schematic oblique drawing showing the external appearance of an image forming apparatus according to Embodiment 7 of the present invention, and FIG. 26 through FIG. 28 are top views of an image forming apparatus according to Embodiment 7 of the present invention. In the following description, descriptions of parts having the same configuration and performing the same operation as in Embodiment 3 are omitted, and elements having the same function are assigned the same reference numbers.

In an image forming apparatus 700 of this embodiment, the configuration and operation of document ejection tray 710 and sheet ejection tray 720 differ from those of document ejection tray 145 and sheet ejection tray 311 in Embodiment 3. Therefore, for this embodiment, the configuration and operation of document ejection tray 710 and sheet ejection tray 720 will be described.

Document ejection tray 710 has a projection 730 as a raised area in one part. Projection 730 stops sheet documents S ejected after image reading, and thereby aligns the edges of sheet documents S. That is to say, document ejection tray 710 has a function of holding ejected sheet documents S with their edges aligned.

Sheet ejection tray 720 has a projection 740 as a raised area in one part. Projection 740 stops printed sheets Ps ejected after an image has been formed, and thereby aligns the edges of printed sheets Ps. That is to say, sheet ejection tray 720 has a function of holding ejected printed sheets Ps with their edges aligned.

The operation of image forming apparatus 700 configured as described above will now be explained using FIG. 26 through FIG. 28. An example will be described here in which feeding, reading, and ejection of sheet documents S of different sizes are performed continuously, and image forming on, and ejection of, printed sheets Ps of different sizes are performed continuously.

First, sheet documents S to be fed automatically are set on the document feed tray. Then, when the user presses the Copy button on the operation panel, a sheet document S on the document feed tray is fed by the document feed rollers, image information of sheet document S is read, and sheet document S is ejected onto document ejection tray 710 of the automatic document feeder by the document ejection rollers. At this time, sheet documents S are stopped, and their edges aligned, by projection 730. That is to say, sheet documents S are stacked with their ejection direction downstream sides aligned.

For this purpose, it is desirable for the rotational speed of the document ejection rollers that convey sheet documents S to document ejection tray 710 to be set greater than or equal to a rotational speed whereby the front edge of a minimum-size sheet document S reaches projection 730. By this means, sheet documents S of different sizes can be aligned with reference to projection 730.

As a separate means of aligning sheet documents S with projection 730, the surface of document ejection tray 710 can be given a gradient that is highest on the automatic document feeder side and becomes lower toward projection 730.

As the operator removes stacked sheet documents S from the end opposite the automatic document feeder, when sheet document S edges are aligned on the side opposite automatic document feeder 140, even a plurality of sheet documents S of different sizes stacked on document ejection tray 710 can easily be removed at one time with one hand.

Meanwhile, image forming section 130 forms an image on a sheet P using image data of sheet document S converted to print data. Printed sheets Ps on which an image has been formed are ejected onto sheet ejection tray 720 of the sheet ejection section by the sheet ejection rollers. At this time, printed sheets Ps are stopped, and their edges aligned, by projection 740. That is to say, printed sheets Ps are stacked with their ejection direction downstream sides aligned.

For this purpose, it is desirable for the rotational speed of the sheet ejection rollers that convey printed sheets Ps to sheet ejection tray 720 to be set greater than or equal to a rotational speed whereby the front edge of a minimum-size printed sheet Ps reaches projection 740. By this means, printed sheets Ps of different sizes can be aligned with reference to projection 740.

As a separate means of aligning printed sheets Ps with projection 740, the surface of sheet ejection tray 720 can be given a gradient that is highest at sheet ejection aperture 155 and becomes lower toward projection 740.

As the operator removes stacked printed sheets Ps from the end opposite sheet ejection aperture 155, when printed sheet Ps edges are aligned on the side opposite sheet ejection aperture 155, even a plurality of printed sheets Ps of different sizes stacked on sheet ejection tray 720 can easily be removed at one time with one hand.

Thus, even when sheet documents S and printed sheets Ps of different sizes are ejected consecutively, sheet documents S and printed sheets Ps can be held with their respective ejection-direction edges aligned.

For both sheet documents S and printed sheets Ps, it is further desirable for not only the ejection-direction edges but also other edges to be aligned. That is to say, by aligning sheet document S and printed sheet Ps edges not only vertically but also laterally with respect to the direction of ejection, printed sheets Ps can be removed still more easily.

As the operator removes stacked printed sheets Ps from the end opposite automatic document feeder 140, it is desirable for the laterally aligned edges to be the edges furthest from automatic document feeder 140 (“A” in FIG. 26). Printed sheets Ps can be aligned at “A ” by providing one edge of a cursor (not shown) in the paper cassette on the same line as “A”.

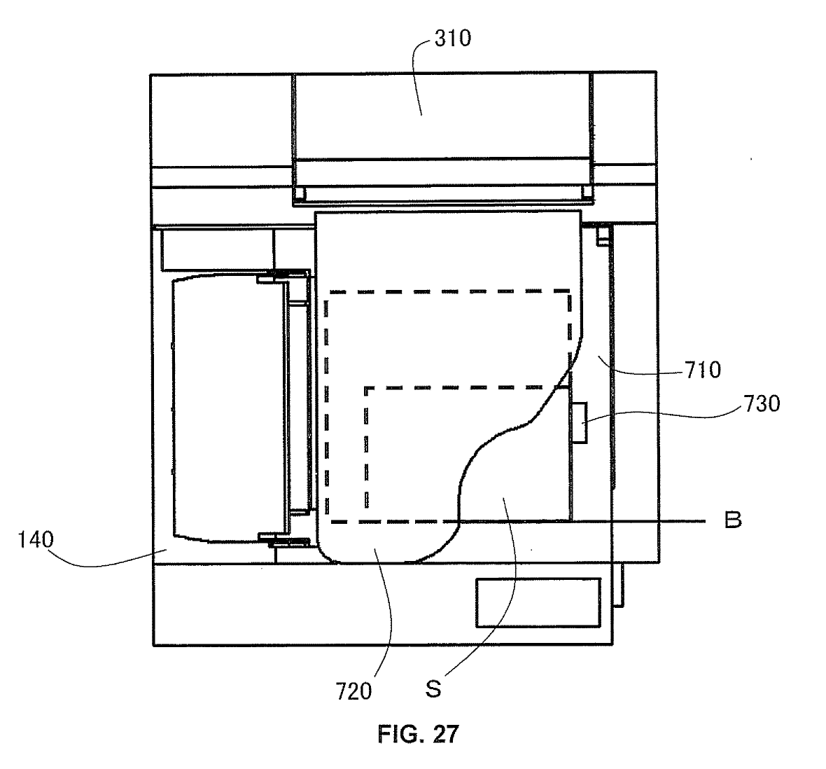

Also, as the operator removes stacked sheet documents S from the end opposite sheet ejection aperture 155, it is desirable for the laterally aligned edges to be the edges furthest from sheet ejection aperture 155 (“B” in FIG. 27). Sheet documents S can be aligned at “B” by providing a position regulating surface of a document position regulating plate for regulating the position of sheet documents S on the document feed tray on the same line as “B”.

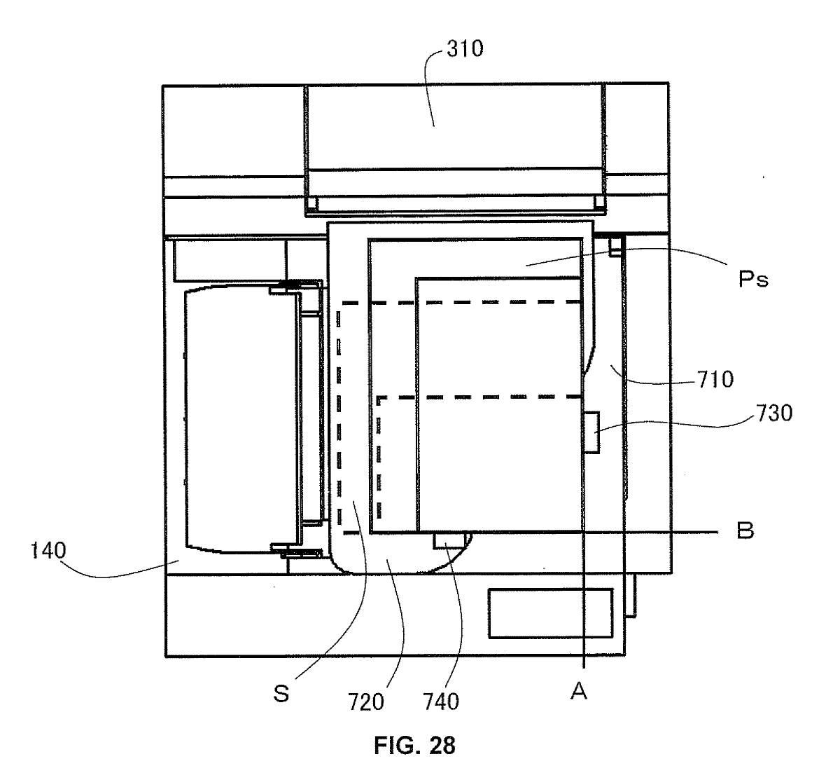

Furthermore, as shown in FIG. 28, projection 730 may be positioned on the same line as printed sheet Ps ejection reference “A”, and projection 740 may be positioned on the same line as sheet document S ejection reference “B”. By this means, the corners of all printed sheets Ps and sheet documents S are aligned, printed sheets Ps and sheet documents S can easily be removed with one hand even when of different sizes, and printed sheets Ps and sheet documents S can easily be differentiated since they are crosswise to each other.

Thus, according to this embodiment, a part of document ejection tray 710 is provided with a projection 730 that stops sheet documents S ejected after image reading and aligns the edges of sheet documents S, and a part of sheet ejection tray 720 is provided with a projection 740 that stops printed sheets Ps on which an image has been formed and aligns the edges of printed sheets Ps, enabling sheet documents S and printed sheets Ps of different sizes to be differentiated and removed easily.

The present invention is not limited to the above-described embodiments, and various variations and modifications may be possible without departing from the scope of the present invention.

This application is based on Japanese Patent Application No. 2005-178784 filed on Jun. 20, 2005, and Japanese Patent Application No. 2006-127948 filed on May 1, 2006, the entire content of which is expressly incorporated by reference herein.

What is claimed is:

1. An image forming apparatus comprising:
an image forming section that forms an image;
a sheet ejection platform that holds printed paper on which an image has been formed by the image forming section and that is ejected toward a top surface of an apparatus body;
a document reading section that reads a document;
a document feed platform that holds a document that is automatically fed to the document reading section; and
a document ejection platform that holds a document fed from the document feed platform and ejected;
wherein a direction of ejection of printed paper placed on the sheet ejection platform intersects a direction of ejection of a document placed on the document ejection platform.

2. The image forming apparatus according to claim 1, wherein a lengthwise direction of a document ejected onto the document ejection platform and a lengthwise direction of a printed paper ejected on to the sheet ejection platform are mutually different.

3. The image forming apparatus according to claim 1, wherein the sheet ejection platform and the document ejection platform are provided at different positions with respect to a vertical direction of a top surface of the apparatus body, and are positioned so that at least parts of each overlap in a vertical direction.

4. The image forming apparatus according to claim 1, wherein the sheet ejection platform is positioned so that, with respect to a vertical direction of a top surface of the apparatus body, at least part thereof is between the document feed platform and the document ejection platform.

5. The image forming apparatus according to claim 1, wherein:
the sheet ejection platform is positioned below the document feed platform and above the document ejection platform; and
the document feed platform can adopt a first state in which a document is fed with a part of the sheet ejection platform facing downward thereof covered, and a second state in which displacement from the first state is effected and the covered part of the sheet ejection platform is exposed.

6. The image forming apparatus according to claim 5, wherein the document feed platform is configured so as to be able to be folded up, and in a folded state is accommodated within an installation area of an apparatus body.

7. The image forming apparatus according to claim 1, wherein:
the sheet ejection platform and the document ejection platform are a single ejection platform; and
printed paper ejected toward a top surface of the apparatus body and a document fed from the document feed platform and ejected are placed on the single ejection platform.

8. The image forming apparatus according to claim 7, wherein a document fed from the document feed platform and ejected and printed paper ejected toward a top surface of the apparatus body are ejected alternately onto the single ejection platform.

9. The image forming apparatus according to claim 7, wherein, after all documents fed from the document feed platform and ejected have been ejected onto the single ejection platform, printed paper ejected toward a top surface of the apparatus body is ejected onto the single ejection platform.

10. The image forming apparatus according to claim 9, wherein the document and the printed paper are ejected onto the single ejection platform so that at least parts of their edges are aligned in a vertical direction.

11. The image forming apparatus according to claim 1, further comprising a spindle that is provided in an area upstream in a direction of ejection of the printed paper and whose axial direction is orthogonal to a direction of ejection of the printed paper;
wherein the sheet ejection platform, the document feed platform, and the document ejection platform can be displaced upward by being opened and closed in a plane parallel to an axial direction of the spindle upside of the apparatus body by rotation of the spindle.

12. The image forming apparatus according to claim 1, wherein:
the document ejection platform has a cutaway section for causing a part of a placed document to hang in midair;
the sheet ejection platform has a depressed area for causing a part of placed printed paper to hang in midair; and
the cutaway section and the depressed area are provided in positions in which parts thereof mutually overlap when the apparatus body is viewed from above.

13. The image forming apparatus according to claim 1, wherein:
the image forming apparatus can form images on a plurality of papers of different sizes; and
the sheet ejection platform has a raised area for stopping ejected printed paper and aligning an edge thereof with a predetermined ejection position reference.

14. The image forming apparatus according to claim 13, wherein the sheet ejection platform has a gradient such that a front edge of minimum-size printed paper reaches the raised area.

15. The image forming apparatus according to claim 1, wherein:
the document reading section can read a plurality of documents of different sizes; and
the document ejection platform has a raised area for stopping an ejected document and aligning an edge thereof.

16. The image forming apparatus according to claim 15, wherein the document ejection platform has a gradient such that a front edge of a minimum-size document reaches the raised area.

17. An image forming apparatus comprising:
an image forming section that forms an image on paper;
a document reading section that reads a document;
a document feed platform that holds a document that is automatically fed to the document reading section;
a paper ejection platform that holds ejected paper on which an image has been formed; and
a document ejection platform that holds an ejected document on which a document read operation has been performed;
wherein paper ejected onto the paper ejection platform after an image has been formed, and a document ejected onto the document ejection platform after a read operation has been performed by the document reading section, are accommodated in respective ejection platforms so that lengthwise directions of the paper and the document respectively intersect in a vertical direction.

18. The image forming apparatus according to claim 17, wherein paper ejected onto the paper ejection platform and a document ejected onto the document ejection platform are accommodated onto respective ejection platforms so that at least parts of edges thereof are aligned in a vertical direction.

19. The image forming apparatus according to claim 17, wherein the paper ejection platform and the document ejection platform are separate ejection platforms provided in different positions.

20. The image forming apparatus according to claim 17, wherein the paper ejection platform and the document ejection platform are a single ejection platform.

21. The image forming apparatus according to claim 20, wherein the paper and the documents are ejected alternately sheet by sheet, and are accommodated by the single ejection platform, crossing each other alternately sheet by sheet.

22. The image forming apparatus according to claim 20, wherein the paper and the document are ejected in batch mode for all paper and for all documents, and are accommodated by the single ejection platform, with all paper and all documents crossing each other.

23. An image forming apparatus comprising:
an image forming section that forms an image on paper;
a document reading section that reads a document;
a document feed platform that holds a document that is automatically fed to the document reading section;
a paper election platform that holds ejected paper on which an image has been formed; and
a document ejection platform that holds an ejected document on which a document read operation has been performed;
wherein the paper ejection platform and the document ejection platform are positioned so that at least parts of respective ejection platforms cross each other in a vertical direction.
